(19) United States
(12) Patent Application Publication
(10) Pub. No.: US 2025/0261078 A1
(43) Pub. Date: Aug. 14, 2025

(54) METHOD AND APPARATUS FOR OPTIMIZING CONDITIONAL HANDOVER AND PSCELL CHANGE IN WIRELESS COMMUNICATION SYSTEM

(71) Applicant: Samsung Electronics Co., Ltd., Suwon-si (KR)

(72) Inventors: Seungri JIN, Suwon-si (KR); Sangbum KIM, Suwon-si (KR); June HWANG, Suwon-si (KR)

(21) Appl. No.: 19/054,121

(22) Filed: Feb. 14, 2025

(30) Foreign Application Priority Data
Feb. 14, 2024 (KR) 10-2024-0021273

(51) Int. Cl. H04W 36/36; H04W 36/30

(52) U.S. Cl. CPC H04W 36/362; H04W 36/305

(57) ABSTRACT

A method performed by a terminal in a wireless communication system is provided. The method includes identifying whether a first condition associated with a conditional handover (CHO) and a second condition associated with a conditional primary secondary cell (PSCell) addition or change (CPAC) are met, logging information on a time associated with the first condition or the second condition, receiving, from a first base station, a first message requesting at least one of information on a random access (RA), information on a radio link failure (RLF), information on a handover, information on a PSCell, or the information on the time, and transmitting, to the first base station, a second message comprising at least one of the information on the RA, the information on the RLF, the information on the handover, the information on the PSCell, or the information on the time, wherein the information on the time comprises a first time gap between a first time when the first condition is met and a second time when the second condition is met.

### CROSS-REFERENCE TO RELATED APPLICATION(S)

This application is based on and claims priority under 35 U.S.C. § 119(a) of a Korean patent application number 10-2024-0021273, filed on Feb. 14, 2024, in the Korean Intellectual Property Office, the disclosure of which is incorporated by reference herein in its entirety.

### BACKGROUND

### 1. Field

The disclosure relates to a method and apparatus for optimizing operations related to conditional handover and primary secondary cell (PSCell) change in a wireless communication system. More particularly, the disclosure relates to specific operations of the base station and terminal according to conditions in conditional handover and PSCell change.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

The above information is presented as background information only to assist with an understanding of the disclosure. No determination has been made, and no assertion is made, as to whether any of the above might be applicable as prior art with regard to the disclosure.

### SUMMARY

The terminal may take some time to check whether the conditional handover condition is satisfied and the following conditional PSCell change condition is satisfied, and in this case, the performance related to the conditional handover may be degraded. A specific methods to address this and a specific procedure for reporting related information to the base station may be required.

Aspects of the disclosure are to address at least the above-mentioned problems and/or disadvantages and to provide at least the advantages described below. Accordingly, an aspect of the disclosure is to provide a method and apparatus for optimizing operations related to conditional handover and PSCell change in a wireless communication system.

Additional aspects will be set forth in part in the description which follows and, in part, will be apparent from the description, or may be learned by practice of the presented embodiments.

In accordance with an aspect of the disclosure, an apparatus for optimizing a specific amount of time that required in a step of checking whether the conditional handover condition is satisfied and a following step of checking whether the conditional PSCell change condition is satisfied, in which legacy conditional handover (CHO) is executed according to a specific condition is provided.

In accordance with another aspect of the disclosure, an operation in which the terminal transmits information related to handover or conditional PSCell change to the base station is provided.

In accordance with an aspect of the disclosure, a method performed by a terminal in a wireless communication system is provided. The method includes identifying whether a first condition associated with a conditional handover (CHO) and a second condition associated with a conditional primary secondary cell (PSCell) addition or change (CPAC) are met, logging information on a time associated with the first condition or the second condition, receiving, from a first base station, a first message requesting at least one of information on a random access (RA), information on a radio link failure (RLF), information on a handover, information on a PSCell, or the information on the time, and transmitting, to the first base station, a second message comprising at least one of the information on the RA, the information on the RLF, the information on the handover, the information on the PSCell, or the information on the time, wherein the information on the time comprises a first time gap between a first time when the first condition is met and a second time when the second condition is met.

In accordance with another aspect of the disclosure, a method performed by a first base station in a wireless communication system is provided. The method includes transmitting, to a terminal, a first message requesting at least one of information on a random access (RA), information on a radio link failure (RLF), information on a handover, information on a primary secondary cell (PSCell), or information on a time associated with a first condition or a second condition, and receiving, from the terminal, a second message comprising at least one of the information on the RA, the information on the RLF, the information on the handover, the information on the PSCell, or the information on the time associated with the first condition or the second condition, wherein the information on the time comprises a first time gap between a first time when the first condition is met and a second time when the second condition is met, wherein the first condition is associated with a conditional handover (CHO), and wherein the second condition is associated with a conditional PSCell addition or change (CPAC).

In accordance with another aspect of the disclosure, a terminal in a wireless communication system is provided. The terminal includes a transceiver, and at least one processor coupled with the transceiver and configured to identify whether a first condition associated with a conditional handover (CHO) and a second condition associated with a conditional primary secondary cell (PSCell) addition or change (CPAC) are met, log information on a time associated with the first condition or the second condition, receive, from a first base station, a first message requesting at least one of information on a random access (RA), information on a radio link failure (RLF), information on a handover, information on a PSCell, or the information on the time, and transmit, to the first base station, a second message comprising at least one of the information on the RA, the information on the RLF, the information on the handover, the information on the PSCell, or the information on the time, wherein the information on the time comprises a first time gap between a first time when the first condition is met and a second time when the second condition is met.

In accordance with another aspect of the disclosure, a first base station in a wireless communication system is provided. The first base station includes a transceiver, and at least one processor coupled with the transceiver and configured to transmit, to a terminal, a first message requesting at least one of information on a random access (RA), information on a radio link failure (RLF), information on a handover, information on a primary secondary cell (PSCell), or information on a time associated with a first condition or a second condition, and receive, from the terminal, a second message comprising at least one of the information on the RA, the information on the RLF, the information on the handover, the information on the PSCell, or the information on the time associated with the first condition or the second condition, wherein the information on the time comprises a first time gap between a first time when the first condition is met and a second time when the second condition is met, wherein the first condition is associated with a conditional handover (CHO), and wherein the second condition is associated with a conditional PSCell addition or change (CPAC).

Other aspects, advantages, and salient features of the disclosure will become apparent to those skilled in the art from the following detailed description, which, taken in conjunction with the annexed drawings, discloses various embodiments the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating the architecture of a next-generation mobile communication system according to an embodiment of the disclosure;

FIG. 2 is a diagram illustrating transitions between radio connection states in the next-generation mobile communication system according to an embodiment of the disclosure;

FIG. 3 is a diagram illustrating a process for reporting an RA report according to an embodiment of the disclosure;

FIGS. 4A, 4B, 4C, and 4D are diagrams illustrating a process of executing subsequent conditional PSCell change according to various embodiments of the disclosure;

FIGS. 5A, 5B, and 5C are diagrams illustrating a process of simultaneously executing conditional PSCell changes depending on the CHO with candidate SCGs configuration according to various embodiments of the disclosure;

FIG. 6 is a diagram illustrating a scenario for storing information on whether to execute the CHO with candidate SCGs configuration in the user equipment (UE) according to an embodiment of the disclosure;

FIG. 7 is a diagram illustrating a UE operation for storing and reporting subsequent conditional PSCell change information to the base station according to an embodiment of the disclosure;

FIG. 8 is a diagram illustrating a UE operation for storing and reporting conditional PSCell change information depending on the CHO with candidate SCGs configuration to the base station according to an embodiment of the disclosure;

FIG. 9 is a diagram illustrating a base station operation for receiving enhanced mobility information from the UE and storing the same according to an embodiment of the disclosure;

FIG. 10 is a diagram illustrating the structure of a UE according to an embodiment of the disclosure; and

FIG. 11 is a diagram illustrating the structure of a base station according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, some components in the attached drawings may be exaggerated, omitted, or schematically illustrated. Also, the size of each component is not entirely representative of the actual size. In the drawings, identical or corresponding components may be given the same reference symbols.

The advantages and features of the disclosure and the methods for achieving them will become apparent by referring to the embodiments described below in detail together with the accompanying drawings.

However, the disclosure is not limited to those embodiments disclosed below and may be implemented in various different forms, and these embodiments are provided only to complete the composition of the disclosure and to fully inform a person having ordinary skill in the art to which the disclosure belongs of the scope of the disclosure, and the disclosure is defined only by the scope of the claims. Throughout the specification, identical reference symbols refer to identical components.

Meanwhile, it will be appreciated that blocks of a flowchart and a combination of flowcharts may be executed by computer program instructions. These computer program instructions may be loaded on a processor of a general purpose computer, special purpose computer, or programmable data processing equipment, and the instructions executed by the processor of a computer or programmable data processing equipment create a means for carrying out functions described in blocks of the flowchart. To implement the functionality in a certain way, the computer program instructions may also be stored in a computer usable or readable memory that is applicable in a specialized computer or a programmable data processing equipment, and it is possible for the computer program instructions stored in a computer usable or readable memory to produce articles of manufacture that contain a means for carrying out functions described in blocks of the flowchart. As the computer program instructions may be loaded on a computer or a programmable data processing equipment, when the computer program instructions are executed as processes having a series of operations on a computer or a programmable data processing equipment, they may provide steps for executing functions described in blocks of the flowchart.

In addition, each block of a flowchart may correspond to a module, a segment or a code containing one or more executable instructions for executing one or more logical functions, or to a part thereof. It should also be noted that functions described by blocks may be executed in an order different from the listed order in some alternative cases. For example, two blocks listed in sequence may be executed substantially at the same time or executed in reverse order according to the corresponding functionality.

Here, the word “unit”, “module”, or the like used in the embodiments may refer to a software component or a hardware component such as an field programmable gate array (FPGA) or application-specific integrated circuit (ASIC) capable of carrying out a function or an operation. However, “unit” or the like is not limited to hardware or software. A unit or the like may be configured so as to reside in an addressable storage medium or to drive one or more processors. For example, units or the like may refer to components such as a software component, object-oriented software component, class component or task component, processes, functions, attributes, procedures, subroutines, program code segments, drivers, firmware, microcode, circuits, data, databases, data structures, tables, arrays, or variables. A function provided by a component and unit may be a combination of smaller components and units, and it may be combined with others to compose larger components and units. Components and units may be implemented to drive one or more central processing units (CPUs) in a device or a secure multimedia card.

For the convenience of explanation, some of the terms and names defined in the 3rd generation partnership project (3GPP) standards (standards for 5G, NR, LTE, or similar systems) may be used. In addition, terms and names newly defined in the next-generation communication system (e.g., 6G, beyond 5G system) to which the disclosure can be applied, or terms and names used in the existing communication systems may be used. The use of these terms is not limited to the terms and names of the disclosure, and may be equally applied to systems that comply with other standards, and may be changed to other forms without departing from the subject matter of the disclosure. The embodiments of the disclosure may be easily modified and applied to other communication systems.

Additionally, in an embodiment of the disclosure, the dimension with respect to a block or the like may be represented identically in length or size.

Additionally, in an embodiment of the disclosure, the terms “first” and “second” may refer to various elements regardless of importance and/or order and are used to distinguish one element from another element without limitation. For example, a first component may be denoted as a second component, and vice versa without departing from the scope of the disclosure.

Additionally, in an embodiment of the disclosure, the term “and/or” used in the context of the “X and/or Y” may be interpreted as “X”, or “Y”, or “X and Y”.

Additionally, the terms used in an embodiment of the disclosure are only used to describe particular embodiments and are not intended to limit the disclosure. It will be understood that the terms “comprising”, “including”, “having” and variants thereof, when used in this specification, specify the presence of stated features, figures, steps, operations, elements, components, or combinations thereof, but do not preclude the presence or addition of one or more other features, figures, steps, operations, elements, components, or combinations thereof.

Additionally, in an embodiment of the disclosure, the words or phrase “associated with”, “associated therewith” and variants thereof may mean the following expressions “include”, “be included within”, “interconnect with”, “contain”, “be contained within”, “connect to or with”, “couple to or with”, “be communicable with”, “cooperate with”, “interleave”, “juxtapose”, “be proximate to”, “be bound to or with”, “have”, and “have a property of”.

Additionally, in the disclosure, to determine whether a specific condition is satisfied or fulfilled, an expression such as ‘greater than’ or ‘less than’ may be used, but this is illustrative and does not exclude the use of ‘greater than or equal to’ or ‘less than or equal to’. In a certain condition, ‘greater than or equal to’, ‘less than or equal to’, and ‘greater than or equal to and less than’ may be replaced with ‘greater than’, ‘less than’, and ‘greater than and greater than or equal to’, respectively.

Additionally, in the disclosure, although the embodiments are described using terms used in some communication standards (e.g., long term evolution (LTE) and new radio (NR) defined by 3rd generation partnership project (3GPP)), these are illustrative only for explanation. The embodiments of the disclosure may be applied to other communication systems with easy modifications.

Before a detailed description of the disclosure, examples of possible interpretations of some terms used in this specification are provided. However, it should be noted that the terms are not limited to the interpretation examples provided below.

In the disclosure, the “terminal (or, communication terminal)” is an entity communicating with a base station or another terminal, and may be referred to as node, user equipment (UE), NG UE (next generation UE), mobile station (MS), or device. Additionally, the terminal may be at least one of a smartphone, a tablet personal computer (PC), a mobile phone, a video phone, an e-book reader, a desktop PC, a laptop PC, a netbook computer, a personal digital assistant (PDA), a portable multimedia player (PMP), a moving picture experts group 1 or phase 1 (MPEG-1) Audio Layer 3 (MP3) player, a medical instrument, a camera, or a wearable device. Additionally, the terminal may be at least one of a television (TV), a digital versatile disc (DVD) player, an audio player, a refrigerator, an air conditioner, a cleaner, an oven, a microwave oven, a washing machine, an air purifier, a set-top box, a home automation control panel, a security control panel, a media box, a game console, an electronic dictionary, an electronic key, a camcorder, or a digital photo frame. Additionally, the terminal may be at least one of a medical device (e.g., portable medical meter (such as a blood glucose meter, a heart rate meter, a blood pressure meter, or a temperature meter), a magnetic resonance angiography (MRA) instrument, a magnetic resonance imaging (MRI) instrument, a computed tomography (CT) instrument, a medical scanner, or an ultrasonic device), a navigation equipment, a global navigation satellite system (GNSS), an event data recorder (EDR), a flight data recorder (FDR), an automotive infotainment device, a marine electronic equipment (e.g., a marine navigation device, and a gyro compass or the like), avionics, a security device, a car head unit, an industrial or home robot, a drone, an automatic teller machine (ATM) for banks, a point-of-sale (POS) system for shops, or an internet of things (IoT) device (e.g., an electronic bulb, a sensor, a sprinkler device, a fire alarm, a thermostat, a streetlamp, a toaster, a fitness equipment, a hot-water tank, a heater, or a boiler). In addition, the terminal may be one of various types of multimedia systems capable of performing communication functions. Meanwhile, the disclosure is not limited to those described above, and the terminal may also be referred to by a term having the same or similar meaning.

Additionally, in the disclosure, the base station is an entity that communicates with the terminal and performs resource allocation to the terminal, may have various forms, and may be referred to as a base station (BS), a NodeB (NB), an next generation radio access network (NG RAN), an access point (AP), a transmission reception point (TRP), a wireless access unit, a base station controller, or a node on the network. Alternatively, the base station may be referred to as a central unit (CU) or a distributed unit (DU) depending on the functional splitting. Meanwhile, the disclosure is not limited thereto, and the base station may also be referred to by a term having the same or similar meaning.

Additionally, in the disclosure, the radio resource control (RRC) message may be referred to as higher level information, higher level message, higher level signal, higher level signaling, or higher layer signaling. The disclosure is not limited thereto and it may also be referred to by a term having the same or similar meaning.

Additionally, in the disclosure, data may be referred to as user data, UP (user plane) data, or application data, and may also be referred to by a term having the same or similar meaning as signals transmitted and received through a data radio bearer (DRB).

Additionally, in the disclosure, the direction of data transmitted from the terminal may be referred to as uplink (UL), and the direction of data transmitted to the terminal may be referred to as downlink (DL). Hence, in the case of uplink transmission, the transmitter may refer to the terminal, and the receiver may refer to the base station or a specific network entity of the communication system. Alternatively, in the case of downlink transmission, the transmitter may refer to the base station or a specific network entity of the communication system, and the receiver may refer to the terminal.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

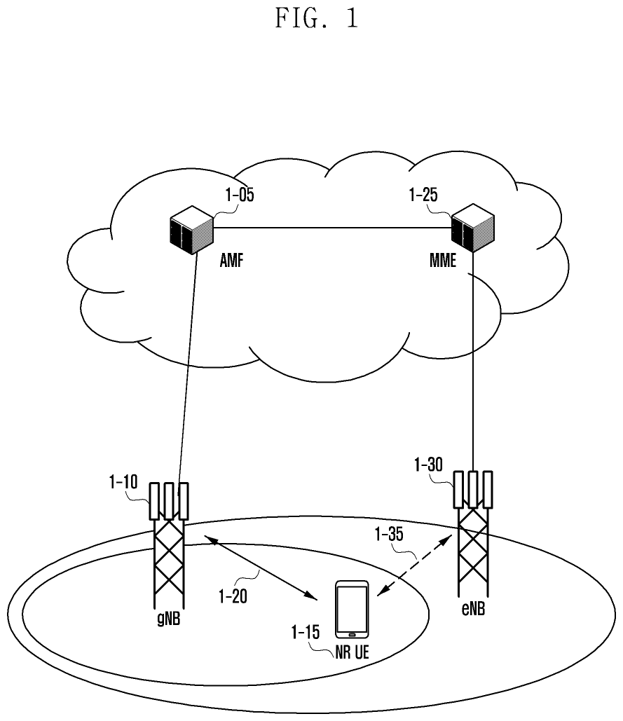

FIG. 1 is a diagram illustrating the architecture of a next-generation mobile communication system according to an embodiment of the disclosure.

Reference to FIG. 1, as shown in the drawing, the radio access network of a next-generation mobile communication system (e.g., new radio, NR) may be composed of a next-generation base station (e.g., new radio node B, gNB) 1-10 and an AMF (e.g., access and mobility management function or new radio core network) 1-05. A new radio user equipment (hereinafter, NR UE or UE) 1-15 may connect to an external network through the gNB 1-10 and the AMF 1-05.

In FIG. 1, the gNB 1-10 may correspond to an evolved node B (eNB) of the existing LTE system. The gNB 1-10 may be connected to the NR UE 1-15 through a radio channel, and it can provide a more superior service than that of the existing node B (1-20). As all user traffic may be serviced through shared channels in the next-generation mobile communication system, there may be a need for an entity that performs scheduling by collecting status information, such as buffer states, available transmission power states, and channel states of UEs, and the gNB 1-10 may take charge of this. In a typical situation, one gNB may control a plurality of cells. Additionally, to implement ultra-high-speed data transmission for the next-generation mobile communication system according to an embodiment, compared with current LTE, a bandwidth beyond the existing maximum bandwidth may be utilized, and a beamforming technology may be additionally combined with orthogonal frequency division multiplexing (OFDM) serving as a radio access technology. Further, an adaptive modulation and coding (AMC) scheme determining a modulation scheme and channel coding rate to match the channel state of the UE may be applied. The AMF 1-05 may perform functions such as mobility support, bearer configuration, and QoS configuration. The AMF 1-05 is an entity taking charge of not only mobility management but also various control functions for the UE, and may be connected to a plurality of base stations. In addition, the next-generation mobile communication system may interwork with the existing LTE system, and the AMF 1-05 may be connected to the MME 1-25 through a network interface. The MME 1-25 may be connected to an eNB 1-30 being a legacy base station. The UE supporting LTE-NR dual connectivity may transmit and receive data while maintaining connections to both the gNB 1-10 and the eNB 1-30 (1-35).

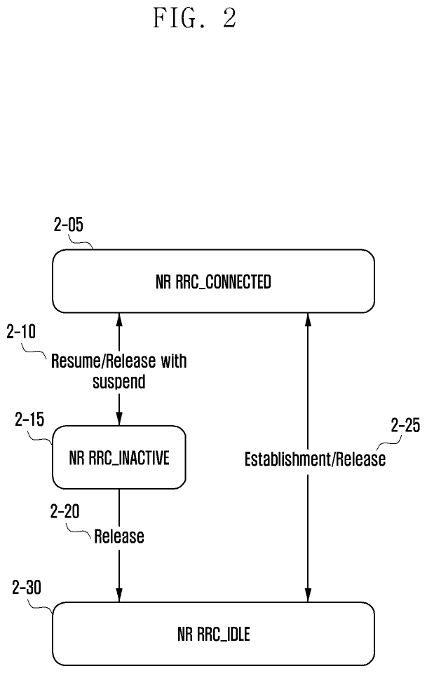

FIG. 2 is a diagram illustrating transitions between radio connection states in the next-generation mobile communication system according to an embodiment of the disclosure.

According to an embodiment, the next-generation mobile communication system may have three radio connection states (RRC states). The connected mode (RRC_CONNECTED, 2-05) may be a radio connection state in which the UE can transmit and receive data. The idle mode (RRC_IDLE, 2-30) may be a radio connection state in which the UE monitors whether paging is transmitted to it. These two modes are a radio connection state that is also applied to the existing LTE system, and the detailed description thereof may be the same as that of the existing LTE system.

According to an embodiment, in the next-generation mobile communication system, an inactive radio connection state (RRC_INACTIVE, 2-15) may be defined. In the inactive radio connection state (2-15), the UE context is maintained in the base station and the UE, and RAN-based paging may be supported. The characteristics of the inactive radio connection state (2-15) may be illustrated as follows.
Cell re-selection mobility;
CN-NR RAN connection (both C/U-planes) has been established for UE;
The UE AS context is stored in at least one gNB and the UE;
Paging is initiated by NR RAN;
RAN-based notification area is managed by NR RAN;
NR RAN knows the RAN-based notification area which the UE belongs to;

The “inactive” radio connection state (2-15) may transition to connected mode (2-05) or idle mode (2-30) by using a specific procedure. Inactive mode (2-15) may transition to connected mode (2-05) according to a resume process (2-10), and connected mode (2-05) may transition to inactive mode (2-15) by using a release procedure (2-10) including suspend configuration information. The above procedure according to an embodiment may transmit and receive one or more RRC messages between the UE and the base station, and may be composed of one or more steps. Also, after resume, inactive mode (2-15) may transition to idle mode (2-30) by using a release procedure (2-20). Transitions between connected mode (2-05) and idle mode (2-30) may follow the existing LTE technology. Further, through an establishment procedure or release procedure (2-25), the transition between these modes may be made.

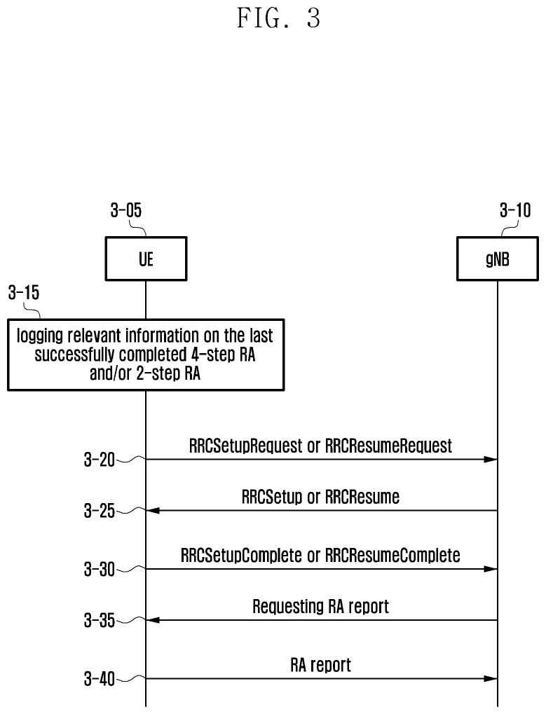

FIG. 3 is a diagram illustrating a process for reporting a random access (RA) report according to an embodiment of the disclosure.

In NR, which can be exemplified as the next-generation mobile communication system, RA report may record and report various types of random access-related information such as 2-step RA as well as 4-step RA.

Referring to FIG. 3, at step 3-15, the UE 3-05 may perform a random access process to the base station 3-10. At this time, specific information related to the most recent successfully performed random access process may be stored. Thereafter, if another random access process is performed and successfully completed, the UE may delete the previously stored information and store specific information related to the new random access process.

According to an embodiment, all random access processes performed during a recent preset time or the most recent N random access processes may be considered. In addition, depending on the purpose of the random access, information related to a failed random access process, in addition to a successful random access process, may also be stored. According to an embodiment, this information may be stored according to the following ASN.1 (abstract syntax notation one) structure and may be reported to the base station. For example, information about one successfully completed random access process may be stored in an information element (e.g., RA-Report IE) and reported, and up to eight RA reports may be stored in an RA-ReportList IE.

A single RA-Report IE may contain information about multiple random access attempts in chronological order (e.g., Per-RAInfoList IE).

The IE stored in Per-RAInfoList (e.g., PerRAInfo IE) may include the above-mentioned information for each SSB or CSI-RS used in random access attempts.

In addition, the PerRAAttemptInfo IE in the IE that may include detailed information related to random access (e.g., PerRAAttemptInfoList) may include information about each random access attempt, information about whether contention is detected for the preamble transmitted according to the random access attempt (e.g., contentionDetected), and information about beam quality related to the random access attempt (e.g., dlRSRPAboveThreshold). The structures of radio resource control (RRC) or IEs according to an embodiment may be illustrated below.

RA-ReportList-r16 ::= SEQUENCE (SIZE (1..maxRAReport-r16)) OF RA-Report-r16

| | |
|---|---|
| RA-Report-r16 ::= | SEQUENCE { |
| cellId-r16 | CHOICE { |
| cellGlobalId-r16 | CGI-Info-Logging-r16, |
| pci-arfcn-r16 | SEQUENCE { |
| physCellId-r16 | PhysCellId, |
| carrierFreq-r16 | ARFCN-ValueNR |

```
      }
    },
```

| | |
|---|---|
| ra-InformationCommon-r16 | RA-InformationCommon-r16, |
| raPurpose-r16 | ENUMERATED {accessRelated, |

beamFailureRecovery, reconfigurationWithSync, ulUnSynchronized,

schedulingRequestFailure,

noPUCCHResourceAvailable, requestForOtherSI,

spare9. spare8, spare7, spare6,

spare5, spare4, spare3, spare2, spare1}
}

| | |
|---|---|
| RA-InformationCommon-r16 ::= | SEQUENCE { |
| absoluteFrequencyPointA-r16 | ARFCN-ValueNR, |
| locationAndBandwidth-r16 | INTEGER (0..37949), |
| subcarrierSpacing-r16 | SubcarrierSpacing, |
| msg1-FrequencyStart-r16 | INTEGER (0..maxNrofPhysicalResourceBlocks−1) |

OPTIONAL,

| | |
|---|---|
| msg1-FrequencyStartCFRA-r16 | INTEGER (0..maxNrofPhysicalResourceBlocks−1) |

OPTIONAL,

| | |
|---|---|
| msg1-SubcarrierSpacing-r16 | SubcarrierSpacing |

OPTIONAL,

| | |
|---|---|
| msg1-SubcarrierSpacingCFRA-r16 | SubcarrierSpacing |

OPTIONAL,

| | |
|---|---|
| msg1-FDM-r16 | ENUMERATED {one, two, four, eight} |

OPTIONAL,

| | |
|---|---|
| msg1-FDMCFRA-r16 | ENUMERATED {one, two, four, eight} |

OPTIONAL,

| | |
|---|---|
| perRAInfoList-r16 | PerRAInfoList-r16 |

```
  }
  PerRAInfoList-r16 ::= SEQUENCE (SIZE (1..200)) OF PerRAInfo-r16
```

| | |
|---|---|
| PerRAInfo-r16 ::= | CHOICE { |
| perRASSBInfoList-r16 | PerRASSBInfo-r16, |
| perRACSI-RSInfoList-r16 | PerRACSI-RSInfo-r16 |

}

| | |
|---|---|
| PerRASSBInfo-r16 ::= | SEQUENCE { |
| ssb-Index-r16 | SSB-Index, |
| numberOfPreamblesSentOnSSB-r16 | INTEGER (1..200), |
| perRAAttemptInfoList-r16 | PerRAAttemptInfoList-r16 |

}

| | |
|---|---|
| PerRACSI-RSInfo-r16 ::= | SEQUENCE { |
| csi-RS-Index-r16 | CSI-RS-Index, |
| numberOfPreamblesSentOnCSI-RS-r16 | INTEGER (1..200) |

}

| PerRAAttemptInfoList-r16 ::= | SEQUENCE (SIZE (1..200)) OF PerRAAttemptInfo-r16 | |
|---|---|---|
| PerRAAttemptInfo-r16 ::= | SEQUENCE { | |
| contentionDetected-r16 | BOOLEAN | OPTIONAL, |
| dlRSRPAboveThreshold-r16 | BOOLEAN | OPTIONAL, |

```
    ...
  }
```

According to FIG. 3, at step 3-20, the UE in idle mode or inactive mode may transmit a message for transitioning to the connected mode (e.g., RRCSetupRequest or RRCResumeRequest message) to the base station.

At step 3-25, the base station may transmit a message related to RRC connection (e.g., RRCSetup or RRCResume message) to the UE, and the UE receiving this message may transition to the connected mode.

At step 3-30, the UE may transmit an RRC message (e.g., RRCSetupComplete or RRCResumeComplete message) to the base station.

At step 3-35, the base station may request the UE to report information related to random access according to an embodiment by using an RRC message (e.g., UEInformationRequest). The structures of radio resource control (RRC) or IEs according to an embodiment may be illustrated below.

| | |
|---|---|
| UEInformationRequest-r16 ::= | SEQUENCE { |
| rrc-TransactionIdentifier | RRC-TransactionIdentifier, |
| criticalExtensions | CHOICE { |
| ueInformationRequest-r16 | UEInformationRequest-r16-IEs, |
| criticalExtensionsFuture | SEQUENCE { } |

```
    }
  }
  UEInformationRequest-r16-IEs ::= SEQUENCE {
```

| | |
|---|---|
| idleModeMeasurementReq-r16 | ENUMERATED(true) |

OPTIONAL, -- Need N

| | | |
|---|---|---|
| logMeasReportReq-r16 | ENUMERATED | (true) |

OPTIONAL, -- Need N

| | | |
|---|---|---|
| connEstFailReportReq-r16 | ENUMERATED | (true) |

OPTIONAL, -- Need N

| | | |
|---|---|---|
| ra-ReportReq-r16 | ENUMERATED | (true) |

OPTIONAL, -- Need N

| | | |
|---|---|---|
| rlf-ReportReq-r16 | ENUMERATED | (true) |

OPTIONAL, -- Need N

| | | |
|---|---|---|
| mobilityHistoryReportReq-r16 | ENUMERATED | (true) |

OPTIONAL, -- Need N

| | | |
|---|---|---|
| lateNonCriticalExtension | OCTET | STRING |

OPTIONAL,

| | |
|---|---|
| nonCriticalExtension | UEInformationRequest-v1700-IEs |

```
OPTIONAL
  }
  UEInformationRequest-v1700-IEs ::= SEQUENCE {
```

| | | |
|---|---|---|
| successHO-ReportReq-r17 | ENUMERATED | (true) |

OPTIONAL, -- Need N

| | | |
|---|---|---|
| coarseLocationRequest-r17 | ENUMERATED | (true) |

OPTIONAL, -- Need N

| | |
|---|---|
| nonCriticalExtension | UEInformationRequest-v1800-IEs |

```
OPTIONAL
  }
  UEInformationRequest-v1800-IEs ::= SEQUENCE {
```

| | |
|---|---|
| flightPathInfoReq-r18 | FlightPathInfoReportConfig-r18 |

OPTIONAL, -- Need N

| | | |
|---|---|---|
| successPSCell-ReportReq-r18 | ENUMERATED | (true) |

OPTIONAL, -- Need N

| | | |
|---|---|---|
| nonCriticalExtension | SEQUENCE | { } |

```
OPTIONAL
  }
  FlightPathInfoReportConfig-r18 ::= SEQUENCE {
```

| maxWayPointNumber-r18 | INTEGER (1..maxWayPoint-r18), | |
|---|---|---|
| includeTimeStamp-r18 | ENUMERATED | (true) |

OPTIONAL
}

At step 3-40, the UE having received the request may transmit a response RRC message (e.g., UEInformationResponse) including the stored information (e.g., RA report information, or the like).

According to an embodiment, the RA report information having been reported to the base station may be deleted. The stored RA report may be deleted by the UE after a certain period of time even if it is not reported to the base station. The structures of radio resource control (RRC) or IEs according to an embodiment may be illustrated below.

| | |
|---|---|
| UEInformationResponse-r16-IEs ::= | SEQUENCE { |
| measResultIdleEUTRA-r16 | MeasResultIdleEUTRA-r16 |

OPTIONAL,

| | |
|---|---|
| measResultIdleNR-r16 | MeasResultIdleNR-r16 |

OPTIONAL,

| | |
|---|---|
| logMeasReport-r16 | LogMeasReport-r16 |

OPTIONAL,

| | |
|---|---|
| connEstFailReport-r16 | ConnEstFailReport-r16 |

OPTIONAL,

| | |
|---|---|
| ra-ReportList-r16 | RA-ReportList-r16 |

OPTIONAL,

| | |
|---|---|
| rlf-Report-r16 | RLF-Report-r16 |

OPTIONAL,

| | |
|---|---|
| mobilityHistoryReport-r16 | MobilityHistoryReport-r16 |

OPTIONAL,

| | |
|---|---|
| lateNonCriticalExtension | OCTET STRING |

OPTIONAL,

| | | |
|---|---|---|
| nonCriticalExtension | UEInformationResponse-v1700-IEs | OPTIONAL |

}

| | |
|---|---|
| UEInformationResponse-v1700-IEs ::= | SEQUENCE { |
| successHO-Report-r17 | SuccesHO-Report-r17 |

OPTIONAL,

| | |
|---|---|
| connEstFailReportList-r17 | ConnEstFailReportList-r17 |

OPTIONAL,

| | |
|---|---|
| coarseLocationInfo-r17 | OCTET STRING |

OPTIONAL,

| | | |
|---|---|---|
| nonCriticalExtension | UEInformationResponse-v1800-IEs | OPTIONAL |

}

| | |
|---|---|
| UEInformationResponse-v1800-IEs ::= | SEQUENCE { |
| flightPathInfoReport-r18 | FlightPathInfoReport-r18 |

OPTIONAL,

| | |
|---|---|
| successPSCell-Report-r18 | SuccessPSCell-Report-r18 |

OPTIONAL,

| | | |
|---|---|---|
| nonCriticalExtension | SEQUENCE { } | OPTIONAL |

}

In addition, as can be seen at steps 3-35 and 3-40, the base station may make a request for information related to random access (e.g., radio link failure (RLF) report, successful (or successive) handover report (SHR), and successful (or successive) PSCell change report (SPR), in addition to RA report), and the UE may respond accordingly. The structures of radio resource control (RRC) or IEs according to an embodiment may be illustrated below.

| | |
|---|---|
| RLF-Report-r16 ::= | CHOICE { |
| nr-RLF-Report-r16 | SEQUENCE { |
| measResultLastServCell-r16 | MeasResultRLFNR-r16, |
| measResultNeightCells-r16 | SEQUENCE { |
| measResultListNR-r16 | MeasResultList2NR-r16 |

OPTIONAL,

| | |
|---|---|
| measResultListEUTRA-r16 | MeasResultList2EUTRA-r16 OPTIONAL |
| } | OPTIONAL, |
| c-RNTI-r16 | RNTI-Value, |
| previousPCellId-r16 | CHOICE { |
| nrPreviousCell-r16 | CGI-Info-Logging-R16, |
| eutraPreviousCell-r16 | CGI-InfoEUTRALogging |

```
                      }
      OPTIONAL,
```

| | |
|---|---|
| failedPCellId-r16 | CHOICE { |
| nrFailedPCellId-r16 | CHOICE { |
| cellGlobalId-r16 | CGI-Info-Logging-r16, |
| pci-arfcn-r16 | PCI-ARFCN-NR-r16 |

},

| | |
|---|---|
| eutraFailedPCellId-r16 | CHOICE { |
| cellGlobalId-r16 | CGI-InfoEUTRALogging, |
| pci-arfcn-r16 | PCI-ARFCN-EUTRA-r16 |

```
                          }
                      },
```

| | |
|---|---|
| reconnectCellId-r16 | CHOICE { |
| nrReconnectCellId-r16 | CGI-Info-Logging-r16, |
| eutraReconnectCellId-r16 | CGI-InfoEUTRALogging |

```
                      }
      OPTIONAL,
```

| | |
|---|---|
| timeUntilReconnection-r16 | TimeUntilReconnection-r16 |

OPTIONAL,

| | |
|---|---|
| reestablishmentCellId-r16 | CGI-Info-Logging-r16 |

OPTIONAL,

| | |
|---|---|
| timeConnFailure-r16 | INTEGER (0..1023) |

OPTIONAL,

| | |
|---|---|
| timeSinceFailure-r16 | TimeSinceFailure-r16, |
| connectionFailureType-r16 | ENUMERATED (rlf, hof), |
| rlf-Cause-r16 | ENUMERATED {t310-Expiry, |

randomAccessProblem, rlc-MaxNumRetx,

beamFailureRecoveryFailure,

lbtFailure-r16,

bh-rlfRecoveryFailure, t312-

expiry-r17, spare1},

| | |
|---|---|
| locationInfo-r16 | LocationInfo-r16 |

OPTIONAL,

| | |
|---|---|
| noSuitableCellFound-r16 | ENUMERATED (true) |

OPTIONAL,

| | |
|---|---|
| ra-InformationCommon-r16 | RA-InformationCommon-r16 |

```
    OPTIONAL,
                    ...,
                    [[
```

| | |
|---|---|
| csi-rsRIMConfigBitmap-v1650 | BIT STRING (SIZE (96)) |

```
    OPTIONAL
                    ]],
                    [[
```

| | |
|---|---|
| lastHO-Type-r17 | ENUMERATED {cho, daps, spare2, spare1} |

OPTIONAL,

| | |
|---|---|
| timeConnSourceDAPS-Failure-r17 | TimeConnSourceDAPS-Failure-r17 |

OPTIONAL,

| | |
|---|---|
| timeSinceCHO-Reconfig-r17 | TimeSinceCHO-Reconfig-r17 |

OPTIONAL,

| | |
|---|---|
| choCellId-r17 | CHOICE { |
| cellGlobalId-r17 | CGI-Info-Logging-r16, |
| pci-arfcn-r17 | PCI-ARFCN-NR-r16 |

```
                    }
    OPTIONAL,
```

| | |
|---|---|
| choCandidateCellList-r17 | ChoCandidateCellList-r17 |

```
    OPTIONAL
                    ]],
                    [[
```

| | |
|---|---|
| pSCellId-r18 | CHOICE { |
| cellGlobalId-r18 | CGI-Info-Logging-r16, |
| pci-arfcn-r18 | PCI-ARFCN-NR-r16 |

```
                    }
    OPTIONAL,
```

| | |
|---|---|
| mcgRecoveryFailureCause-r18 | ENUMERATED {t316-Expiry, scgDeactivated, |

spare2, spare1} OPTIONAL,

| | |
|---|---|
| scgFailureCause-r18 | ENUMERATED (t310-Expiry, |

randomAccessProblem, rlc-MaxNumRetx,

synchReconfigFailureSCG, scg-

ReconfigFailure,

srb3-IntegrityFailure, scg-lbtFailure-

r16, beamFailureRecoveryFailure-r16,

t312-Expiry-r16, bh-RLF-r16,

```
  beamFailure-r17, spare3, spare2, spare1 }
  OPTIONAL,
```

| | |
|---|---|
| elapsedTimeSCGFailure-r18 | ElapsedTimeSCGFailure-r18 |

OPTIONAL,

| | |
|---|---|
| voiceFallbackHO-r18 | ENUMERATED {true} |

OPTIONAL,

| | |
|---|---|
| measResultLastServCell-RSSI-r18 | RSSI-Range-r18 |

OPTIONAL,

| | |
|---|---|
| measResultNeighFreqList-RSSI-r18 | MeasResultNeighFreqList-RSSI-r18 |

OPTIONAL,

| | |
|---|---|
| bwp-Info-r18 | AttemptedBWP-Info-r18 |

OPTIONAL,

| | |
|---|---|
| elapsedTimeT316-r18 | ElapsedTimeT316-r18 |

```
  OPTIONAL
                  ]]
              },
```

| | |
|---|---|
| eutra-RLF-Report-r16 | SEQUENCE { |
| failedPCellId-EUTRA | CGI-InfoEUTRALogging, |
| measResult-RLF-Report-EUTRA-r16 | OCTET STRING, |

```
                  ...,
                  [[
```

| | |
|---|---|
| measResult-RLF-Report-EUTRA-v1690 | OCTET STRING |

```
  OPTIONAL
                  ]]
              }
          }
```

| | |
|---|---|
| SuccessHO-Report-r17 ::= | SEQUENCE { |
| sourceCellInfo-r17 | SEQUENCE { |
| sourcePCellId-r17 | CGI-Info-Logging-r16, |
| sourceCellMeas-r17 | MeasResultSuccessHONR-r17 |

OPTIONAL,

| | |
|---|---|
| rlf-InSourceDAPS-r17 | ENUMERATED (true) |

```
  OPTIONAL
              },
```

| | |
|---|---|
| targetCellInfo-r17 | SEQUENCE { |
| targetPCellId-r17 | CGI-Info-Logging-r16, |
| targetCellMeas-r17 | MeasResultSuccessHONR-r17 |

```
  OPTIONAL
              },
```

| | |
|---|---|
| measResultNeighCells-r17 | SEQUENCE { |
| measResultListNR-r17 | MeasResultList2NR-r16 |

OPTIONAL,

| | |
|---|---|
| measResultListEURTRA-r17 | MeasResultList2EUTRA-r16 |

```
  OPTIONAL
              }
  OPTIONAL,
```

| | |
|---|---|
| locationInfo-r17 | LocationInfo-r16 |

OPTIONAL,

| | |
|---|---|
| timeSinceCHO-Reconfig-r17 | TimeSinceCHO-Reconfig-r17 |

OPTIONAL,

| | |
|---|---|
| shr-Cause-r17 | SHR-Cause-r17 |

OPTIONAL,

| | |
|---|---|
| ra-InformationCommon-r17 | RA-InformationCommon-r16 |

OPTIONAL,

| | |
|---|---|
| upInterruptionTimeAtHO-r17 | UPInterruptionTimeAtHO-r17 |

OPTIONAL,

| | |
|---|---|
| c-RNTI-r17 | RNTI-Value |

```
  OPTIONAL,
              ...,
              [[
```

| | |
|---|---|
| eutraTargetCellInfo-r18 | SEQUENCE { |
| targetPCellId-r18 | CGI-InfoEUTRALogging, |
| targetCellMeas-r18 | MeasQuantityResultsEUTRA |

```
  OPTIONAL
              }
OPTIONAL,
```

| | |
|---|---|
| measResultServCell-RSSI-r18 | RSSI-Range-r16 |

OPTIONAL,

| | |
|---|---|
| measResultNeighFreqList-RSSI-r18 | MeasResultNeighFreqList-RSSI-r18 |

OPTIONAL,

| | |
|---|---|
| eutra-C-RNTI-r18 | EUTRA-C-RNTI |

OPTIONAL,

| | |
|---|---|
| timeSinceSHR-r18 | TimeSinceSHR-r18 |

```
OPTIONAL
              ]]
        }
```

| | |
|---|---|
| SuccessPSCell-Report-r18 ::= | SEQUENCE { |
| pCellId-r18 | CGI-Info-Logging-r16, |
| SourcePSCellInfo-r18 | SEQUENCE { |
| sourcePSCellId-r18 | CGI-Info-Logging-r16, |
| sourcePSCellMeas-r18 | MeasResultSuccessHONR-r17 |

OPTIONAL
}
OPTIONAL,

| | |
|---|---|
| targetPSCellInfo-r18 | SEQUENCE { |
| targetPSCellId-r18 | CHOICE { |
| cellGlobalId-r18 | CGI-Info-Logging-r16, |
| pci-arfcn-r18 | PCI-ARFCN-NR-r16 |

},

| | |
|---|---|
| targetPSCellMeas-r18 | MeasResultSuccessHONR-r17 |

OPTIONAL
},

| | |
|---|---|
| measResultNeighCells-r18 | SEQUENCE { |
| measResultListNR-r18 | MeasResultList2NR-r16 |

OPTIONAL,

| | |
|---|---|
| measResultListEUTRA-r18 | MeasResultList2EUTRA-r16 |

OPTIONAL
}
OPTIONAL,

| | |
|---|---|
| spr-Cause-r18 | SPR-Cause-r18 |

OPTIONAL,

| | |
|---|---|
| timeSinceCPAC-Reconfig-r18 | TimeSinceCPAC-Reconfig-r18 |

OPTIONAL,

| | |
|---|---|
| locationInfo-r18 | LocationInfo-r18 |

OPTIONAL,

| | |
|---|---|
| ra-InformationCommon-r18 | RA-InformationCommon-r16 |

OPTIONAL,

| | |
|---|---|
| sn-InitiatedPSCellChange-r18 | ENUMERATED {true} |

```
OPTIONAL,
        ...
        }
```

In particular, in the disclosure described below, since the base station may receive information about the corresponding operation in the previous cell and utilize it for mobility enhancement technologies (e.g., subsequent conditional PSCell change, conditional handover and conditional PSCell change at the same time, etc.), a method of reporting RA, RLF, SHR, SPR, or the like according to an embodiment may be considered in relation to the illustrated technologies.

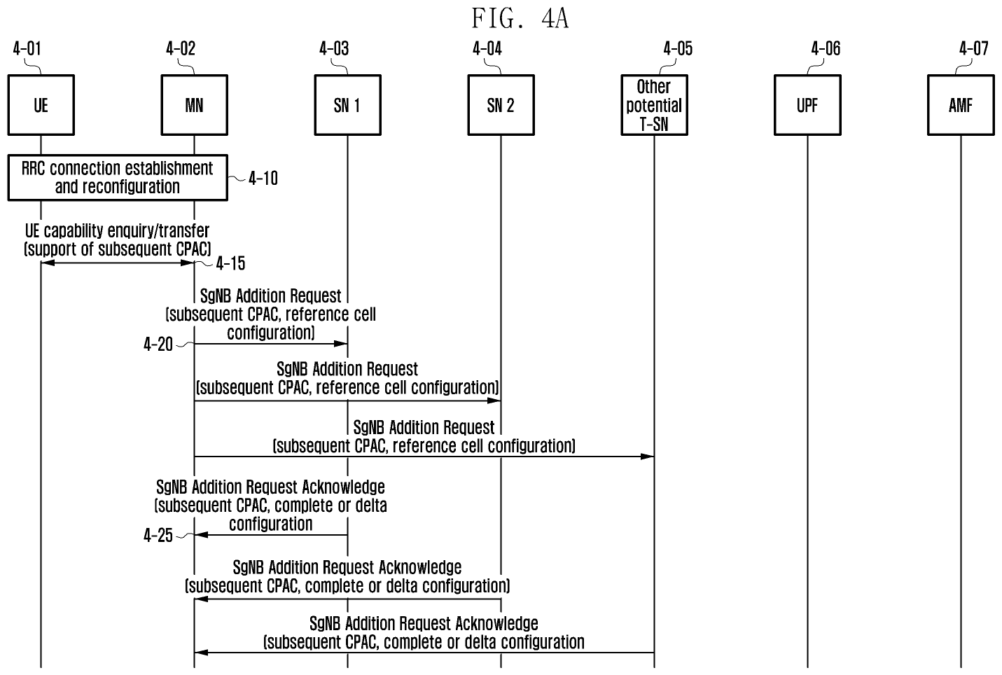

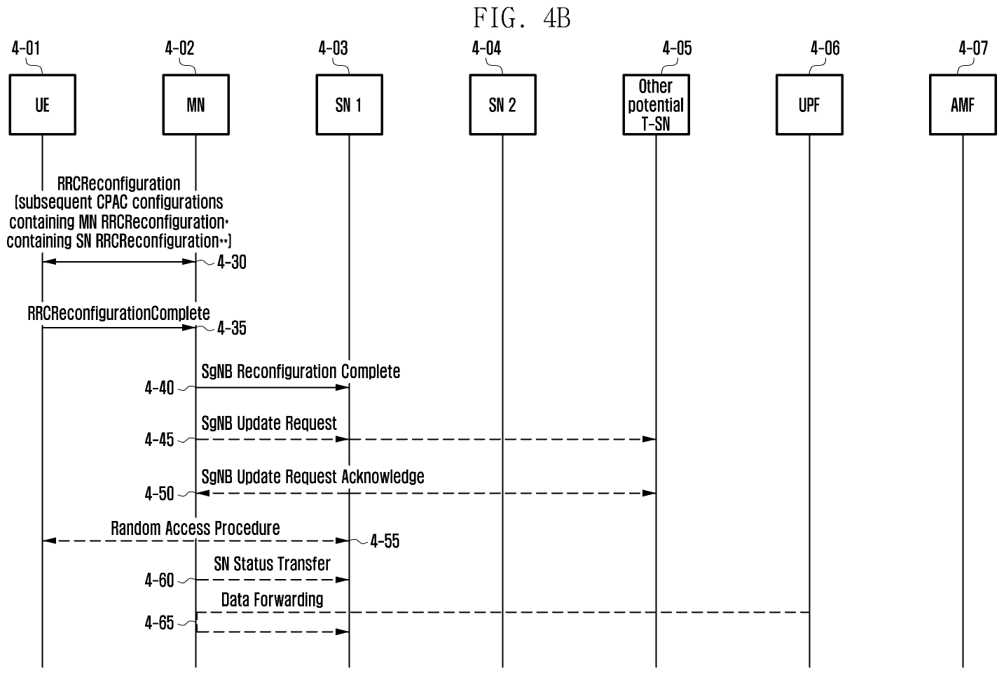

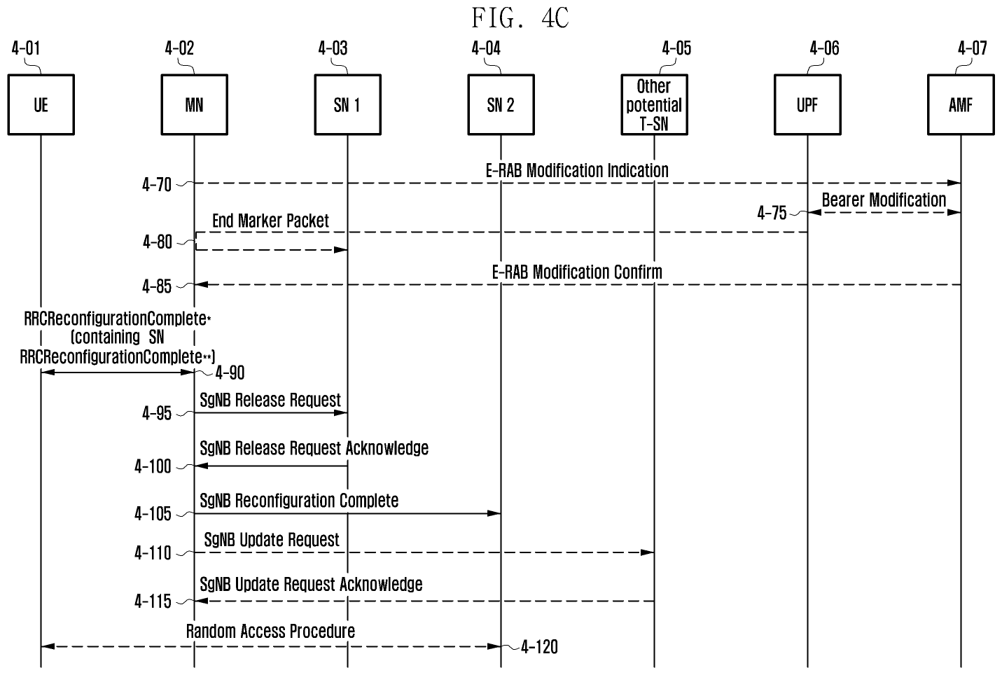

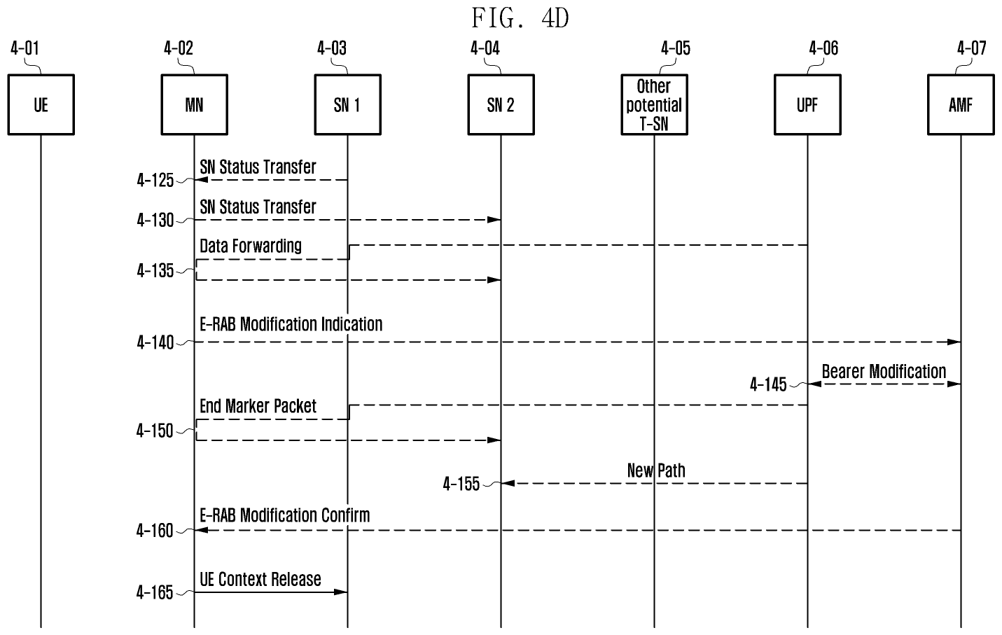

FIGS. 4A to 4D are diagrams illustrating a process of executing subsequent conditional PSCell change according to various embodiments of the disclosure. According to an embodiment, it is possible to illustrate a procedure that enables the UE, to which DC is not configured, to simultaneously receive, from the base station, configurations for conditions for conditional PSCell addition (CPA) and conditional PSCell change (CPC) (conditions for conditional PSCell addition or change (CPAC) and secondary cell group (SCG) related RRC settings), and to store and manage the corresponding configuration information. Additionally, although the disclosure describes a procedure for triggering subsequent conditional PSCell change in the master node (MN) for convenience, subsequent conditional PSCell change may also be triggered in the secondary node (SN), and most of the procedures can be the same.

At step 4-10, the UE 4-01 may perform an RRC connection establishment procedure with the master node (MN) 4-02/base station and perform RRC settings.

At step 4-15, the UE 4-01 and the MN base station 4-02 may identify the UE capability through a procedure of requesting and transmitting the UE capability by using a UE capability request message (e.g., UECapabilityEnquiry) and a UE capability information message (e.g., UECapabilityInformation). According to an embodiment, an indication indicating whether subsequent CPAC is supported may be included in the corresponding UE capability. The above UE capability may be transmitted on a per UE, per band, per band combination, or per feature set basis, and may also be transmitted by distinguishing between CPA and CPC, without being limited thereto.

At step 4-20, the MN base station 4-02 may check whether SN addition to the UE 4-01 is necessary (e.g., by referring to the measurement result from the UE) and may check whether SN nodes 4-03, 4-04 and 4-05 that can become a candidate are capable of SN addition to the UE 4-01.

According to an embodiment, the base station 4-02 may check whether the SN nodes 4-03, 4-04 and 4-05 are capable of SN addition through the procedure of transmitting a message for checking whether SN addition is possible (e.g., sgNB Addition Request) at step 4-20 and receiving, at step 4-25, a response message (e.g., sgNB Addition Request Acknowledge) for the message of step 4-20. Information to check whether subsequent CPAC is applicable (e.g., subsequent CPAC) may be added to the above messages. Additionally, reference cell configuration information for MCG and SCG, which are referenced when configuring CPAC, may be transmitted at step 4-20.

According to an embodiment, the MN and candidate SNs may perform, before step 4-20, a procedure (e.g., inter-node coordination) for determining the MCG and SCG reference cell configuration information that will serve as a reference when the subsequent CPAC operation is executed through a separate procedure.

At step 4-25, the candidate SN nodes 4-03, 4-04 and 4-05 may include configuration information (e.g., MCG and SCG configurations) related to complete configuration or delta configuration for the CPAC configuration in the response message (e.g., sgNB Addition Request Acknowledge) corresponding to the sgNB Addition Request. According to an embodiment, it is assumed that delta configuration is applied upon request, but in case that the SN node fails to apply the delta configuration to the reference cell configuration, the complete configuration may be transmitted. Additionally, in the Xn/F1 message exchange procedure (e.g., steps 4-20 and 4-25), RRC inter-node messages (e.g., CG-Config and CG-ConfigInfo) may include a subsequent CPAC indication, other confirmation indication, and complete configuration indication.

At step 4-30, the MN base station 4-02 may transmit, to the UE 4-01, the CPAC-related configuration information (conditions for CPAC and SCG related RRC configuration) received from the candidate SNs that have allowed SN addition, particularly CPAC, to the UE at step 4-20/4-25, by including it in an RRC configuration message (e.g., RRCConnectionReconfiguration, RRCReconfiguration). According to an embodiment, in the EN-DC situation, the CPAC related configuration for the SN is encapsulated in an RRCConnectionReconfiguration message, and in the NE-DC or NR-DC situation, the CPAC related configuration for the SN may be encapsulated in an RRCReconfiguration message, without being limited to the message format or name. According to an embodiment, the SN CPAC related configuration information that can be included in the RRC configuration may include CPA and/or CPC configuration information for supporting the subsequent conditional PSCell addition or change procedure, and the base station 4-02 may configure the CPA and CPC configurations together and transmit the related information to the UE 4-01 by including it in an RRC message. The CPAC related configuration information may include information such as conditions for SN CPAC, or MCG and/or SCG configurations that may be applied after SN CPAC execution. According to an embodiment, the CPAC-related configuration may be provided without a separate indication to subsequent CPAC.

According to an embodiment, the UE 4-01 may keep or store the CPAC related configuration even after SCG change. Hence, the UE 4-01 may continue to evaluate the stored CPAC conditions even after the SCG change without releasing the received CPAC configuration, and if satisfied, may trigger the corresponding CPC and perform the CPC operation from the current PSCell toward the target PSCell. This operation may be continued until separate release information or indication for subsequent CPAC operation is received from the base station 4-02. Alternatively, this operation may be continued for a period of time via a timer set through a step according to an embodiment or until a specific condition is met.

In step 4-35, the UE 4-01 may transmit a response message (e.g., RRCReconfigurationComplete message) to the MN base station 4-02 in reply to reception of the RRC configuration (4-30) (including MN and SN configurations or CPAC-related configuration information), and then, if the CPAC-related condition received from a specific SN (e.g., SN 1 (4-03)) is satisfied, the terminal 4-01 may trigger an SN addition procedure toward the corresponding SN (e.g., SN 1 (4-03)). Additionally, the UE 4-01 may generate an MN RRCReconfigurationComplete message including an SN RRCReconfigurationComplete (or, sgNB Reconfiguration Complete) message for the SN for which the SN addition procedure is triggered (the SN whose CPA condition is satisfied), and transmit it to the MN base station 4-02.

At step 4-40, the MN base station 4-02 may notify the SN base station whose CPA condition is satisfied of the SN addition operation of the UE 4-01 by transmitting a sgNB Reconfiguration Complete message to the SN base station (e.g., 4-03) to which the UE 4-01 applies the SN addition.

At step 4-45, the MN base station 4-02 may perform a procedure for checking the validity of the CPAC configuration transmitted to the UE 4-01 with the candidate SN base stations to which SN addition is not applied. At this step, whether the previously provided (subsequent) CPAC configuration is still valid after the SCG change or need to be updated may be requested. The base station 4-02 may transmit a request message (e.g., SgNB Update Request message, other Xn message, or RRC inter-node message) for checking the validity or update to the candidate SN base stations.

At step 4-50, each candidate SN may transmit a message (e.g., SgNB Release Request Acknowledge or RRC inter-node message) including update information of (subsequent) CPAC configuration to the base station 4-02 in reply to the above message. In an embodiment, steps 4-45 and 4-50 may be omitted depending on the implementation. Additionally, at this step, delta configuration and complete configuration requests may be made for the CPAC configuration, and the corresponding CPAC configuration may be provided.

At step 4-55, the UE 4-01 may perform a random access procedure for SN addition to the SN for which the CPA is triggered. According to an embodiment, this operation may be performed only when a security key update is required, and may be omitted in other cases.

At step 4-60, the MN base station 4-02 may transfer the SN (sequence number) status to the SN base station 4-03.

At step 4-65, the MN base station 4-02 may forward data from the UPF (user plane function) 4-06 to the SN base station 4-03.

At step 4-70, as an operation for path update, the MN base station 4-02 may transmit a PDU session resource (e.g., E-UTRAN radio access bearer, E-RAB) modification indication to the AMF 4-07.

At step 4-75, the AMF 4-07 and the UPF 4-06 may perform a bearer (e.g. E-UTRAN radio access bearer, E-RAB) modification procedure.

At step 4-80, the UPF 4-06 may transmit a PDU packet including an End marker to the MN base station 4-02 to indicate a modification of the previous bearer (e.g., E-UTRAN radio access bearer, E-RAB).

At step 4-85, the AMF 4-07 may transmit, to the MN base station 4-02, a PDU session resource modification confirmation message (e.g., E-RAB modification confirm) containing information indicating completion of the PDU session resource modification.

According to an embodiment, the procedure for indicating an update of subsequent CPAC operation may be triggered at any time by a confirmation between base stations, and modification and release of the CPAC configuration may be explicitly performed via RRC messages. In the corresponding step, CPA and CPC configurations related to embodiments of the disclosure may be transmitted simultaneously.

Thereafter, if a CPAC related condition received from a specific SN is satisfied, the UE may trigger an SN change procedure for the corresponding SN.

At step 4-90, the UE 4-01 may generate an MN RRCReconfigurationComplete message including an SN RRCReconfigurationComplete (or, sgNB Reconfiguration Complete) message for the SN (e.g., SN 2 (4-04)) where the SN change procedure is triggered (the SN for which the CPAC condition is satisfied), and transmit it to the MN base station (4-02).

At step 4-95, the MN base station 4-02 may transmit a request message (e.g., SgNB Release Request message) for SCG configuration release to the source SN base station 4-03.

At step 4-100, the source SN base station 4-03 may respond to the release request message by transmitting a response message (e.g., SgNB Release Request Acknowledge message).

At step 4-105, the MN base station 4-02 may notify the SN change operation of the UE by transmitting a sgNB Reconfiguration Complete message to the target SN base station (e.g., SN 2, 4-04) at which the CPAC condition is satisfied (i.e., to which the UE 4-01 triggers an SN change).

At step 4-110, the MN base station 4-02 may perform a procedure of checking the validity of the CPAC configuration transmitted to the UE to the candidate SN base stations (e.g., 4-05) to which SN change is not applied. That is, at this step, it may be checked whether the previously provided (subsequent) CPAC configuration is still valid after the SCG change or needs an update. The base station 4-02 may transmit a request message (e.g., SgNB Update Request message, other Xn message, or RRC inter-node message) for checking the validity or update necessity to the candidate SN base stations.

At step 4-115, each candidate SN may transmit a message (e.g., SgNB Release Request Acknowledge or RRC inter-node message) including update information on the (subsequent) CPAC configuration in response to the above request message. According to an embodiment, steps 4-110 and 4-115 may be omitted depending on the implementation. At these steps, a request for delta configuration or complete configuration may be made for the CPAC configuration and the corresponding CPAC configuration may be transmitted. In addition, the subsequent CPAC operation that may be repeatedly performed thereafter is omitted in this drawing, but the UE may continue to apply the received CPAC configuration to perform related operations (CPC triggering and CPC execution).

At step 4-120, the UE may perform a random access procedure for SN change to the target SN (SN 2 (4-04)) for which the CPC is triggered. This operation may be performed only when a security key update is required, and may be omitted in other cases.

At step 4-125, the MN base station 4-02 may receive the SN (sequence number) status from the source SN base station 4-03.

At step 4-130, the MN base station 4-02 may forward the received SN (sequence number) status to the target SN base station 4-04.

At step 4-135, a procedure for forwarding data from the UPF 4-06 to the target SN base station 4-04 may be performed.

At step 4-140, as an operation for path update, the MN base station 4-02 may transmit a PDU session resource modification indication to the AMF 4-07.

At step 4-145, the AMF 4-07 and the UPF 4-06 may perform a bearer modification procedure.

At step 4-150, the UPF 4-06 may transmit a PDU packet containing an End marker to the MN base station 4-02 to indicate a modification of the previous bearer.

At step 4-155, the UPF 4-06 may indicate a new path to the target SN base station 4-04.

At step 4-160, the AMF 4-07 may transmit a PDU session resource modification confirmation message indicating completion of PDU session resource modification to the MN base station 4-02.

At step 4-165, the MN base station 4-02 may indicate UE context release to the source SN base station 4-03.

Some of the steps related to FIGS. 4A to 4D may be omitted or listed in combination, without being limited to the above description.

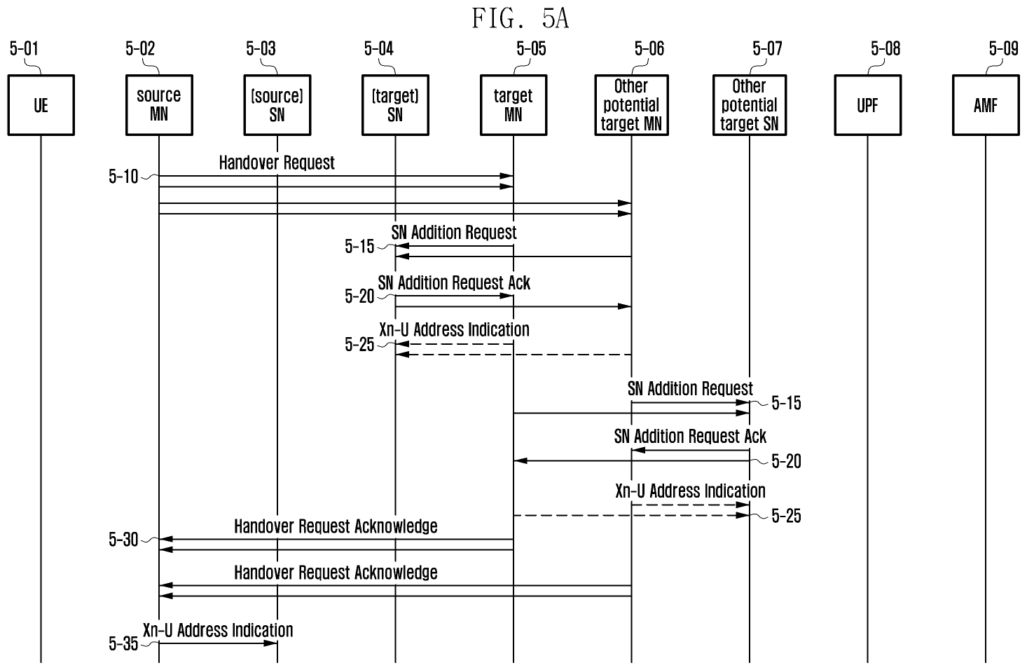

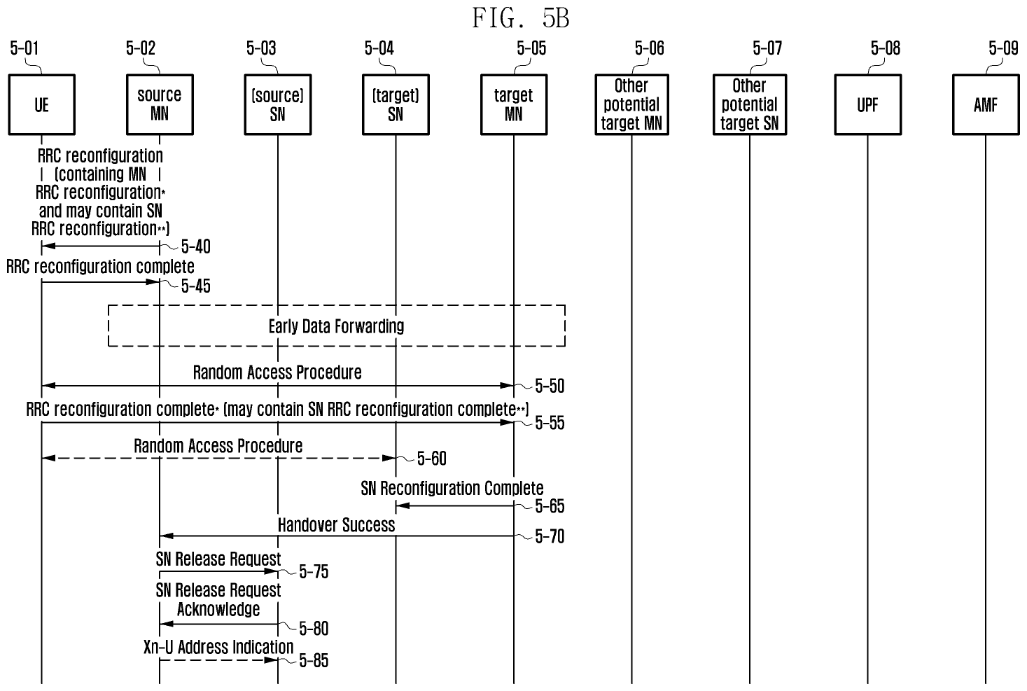

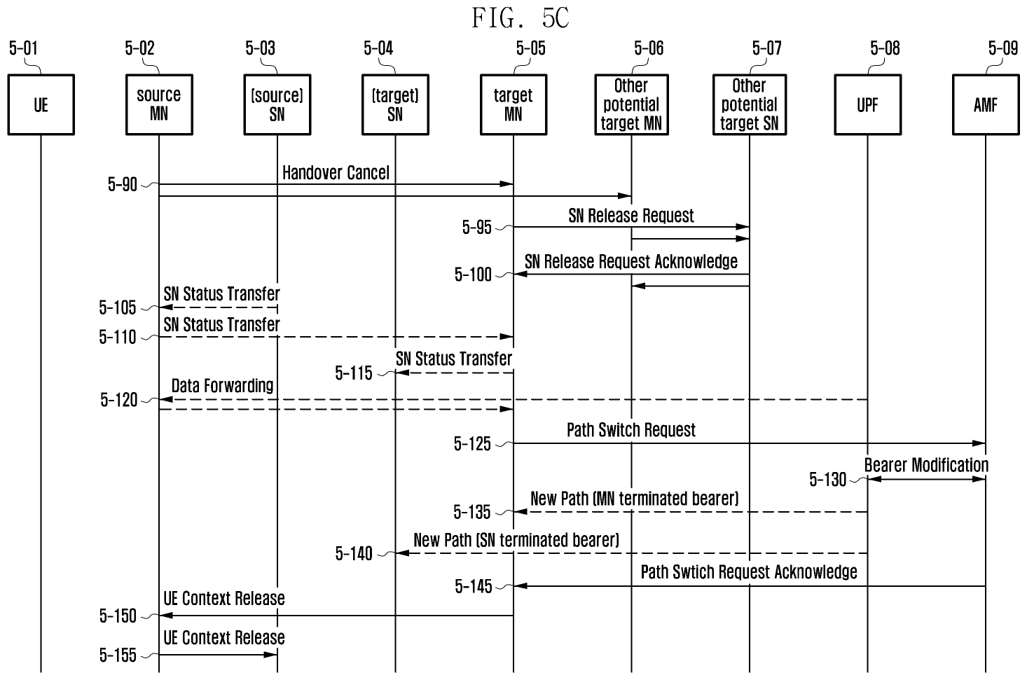

FIGS. 5A to 5C are diagrams illustrating a process of simultaneously executing conditional PSCell changes depending on the CHO with candidate SCGs configuration according to various embodiments of the disclosure.

At step 5-10, the source MN 5-02 may transmit, based on the measurement report value from the UE 5-01, a message (e.g., Handover Request message) requesting a conditional handover (CHO) toward target cells to the target MNs 5-05 and 5-06. In this step, the source MN 5-02 may make a request for the configuration for CHO with multiple candidate SCGs (CHO with candidate SCGs), in which case the MN may also transmit information about the maximum conditional configurations that may be configured to the UE.

At step 5-15, the target MNs 5-05 and 5-06 may transmit a request message (e.g., SN Addition Request message) to the SNs 5-04 and 5-07 including candidate PSCells for which the CHO with candidate SCGs configuration may be configured. According to an embodiment, the maximum number of PSCells that can be configured in the candidate SN may be transmitted together with the above configuration through the request message.

At step 5-20, the target SNs 5-04 and 5-07 may transmit, to the target MNs 5-05, and 5-06, a response message (e.g., SN Addition Request Ack message) including at least one of a list of PSCells to which the CHO with candidate SCGs configuration may be applied, and SCG SCells that may be configured together, or an RRC configuration applicable to the corresponding PSCell/SCells.

At step 5-25, for SN terminated bearers utilizing MCG resources, the target MNs 5-05 and 5-06 may transmit a message containing Xn-U DL TNL (transport network layer) address information (e.g., Xn-U Address Indication message).

At step 5-30, the target MNs 5-05 and 5-06 may transmit, to the source MN 5-02, an acknowledgement message for the conditional handover request (e.g., Handover Request Acknowledge message) including an RRC message that may include configuration information applied when configuring the CHO with candidate SCGs configuration received in the above step from the candidate SNs.

At step 5-35, the source MN 5-02 may transmit an Xn-U Address Indication message to the source SN 5-03 so as to notify that a CHO operation may occur to that SN and indicate early data forwarding for the SN terminated bearer if necessary.

At step 5-40, the source MN 5-02 may generate an RRC reconfiguration message including the CHO with multiple candidate SCGs configuration information received from the target MN at step 5-30 and transmit it to the UE 5-01. The above message may be generated in the MN RRC configuration format and be transmitted by encapsulating SN RRC configuration information.

According to an embodiment, for the CHO configuration and the PCell to which the CHO configuration is applied, information on multiple SCG configurations to which conditional PSCell change (CPC) can be applied can be transmitted together. Here, the configuration of CHO with candidate SCGs may mean that two mobility technologies are performed simultaneously when two conditions (CHO condition, CPC condition) for MN and SN are satisfied at the same time. First, it is checked whether the CHO condition is satisfied, and then the CPC condition (e.g., condExecutionCond-r16) that can be performed simultaneously with the PCell to which the CHO is performed can be checked. Due to this, there may be an interruption time between evaluation of the CHO condition and following evaluation of the CPC condition (condExecutionCondPSCell-r18) for the multiple candidate PSCells. The structure of information according to an embodiment can be illustrated through ASN.1 (or, RRC message, IE) below.

| | |
|---|---|
| CondReconfigToAddMod-r16 ::= | SEQUENCE { |
| condReconfigId-r16 | CondReconfigId-r16, |

| | |
|---|---|
| condExecutionCond-r16 | SEQUENCE (SIZE (1..2)) OF MeasId |

OPTIONAL, -- Need M

| | |
|---|---|
| condRRCReconfig-r16 | OCTET STRING (CONTAINING RRCReconfiguration) |

```
OPTIONAL, -- Cond measReconfig [symbol]
    ...,
    [[
```

| | |
|---|---|
| condExecutionCondSCG-r17 | OCTET STRING (CONTAINING CondReconfigExecCondSCG-r17) |

```
OPTIONAL -- Need M
    ]],
    [[
```

| | |
|---|---|
| cond [symbol] Cell-r [symbol] | SEQUENCE SIZE (1..21) OF MeasId |

OPTIONAL, -- Cond [symbol] Reconfig

[symbol]

| | |
|---|---|
| [symbol] | SubsequenceCondReconfig-r [symbol] |

OPTIONAL, -- Need M

| | |
|---|---|
| [symbol] Cell [symbol] | [symbol] Cell [symbol] Id-r [symbol] |

OPTIONAL, -- Need M

| | |
|---|---|
| [symbol] | ENUMERATED (true) |

```
OPTIONAL -- Cond CPAC
    ]]
  }
```

| | |
|---|---|
| condReconfigCHO- | This field is optional present need M if the RRCReconfiguration message |
| [symbol] SCG | contained in corresponding condRRCReconfig includes the [symbol] SCG and |
| | condExecutionCond is configured. Otherwise, it is absent. |

[symbol]

indicates data missing or illegible when filed

According to an embodiment, since the performance may be lowered in terms of interruption compared to the legacy CHO, when the network base station provides the CHO with candidate SCGs configuration, the legacy CHO configuration may be transmitted together for the same PCell so that the legacy CHO can be executed when interruption of a specific time or more is expected to occur. According to an embodiment, the condition (e.g., threshold, etc.) applied to the CHO with candidate SCGs configuration may be set differently from the condition (e.g., threshold, etc.) applied to the legacy CHO.

At step 5-45, the UE 5-01 may apply the RRC configuration received at step 5-40, generate a message indicating that the corresponding message has been properly received (e.g., RRC reconfiguration complete message), and transmit it to the source MN 5-02.

According to an embodiment, the UE 5-01 may evaluate the conditions received from the CHO with candidate SCGs configuration (or, configuration information), and execute CHO and CPC operations for the corresponding PCell and PSCell when the conditions are simultaneously satisfied.

At step 5-50, the UE 5-01 may perform random access to the target MN 5-05.

At step 5-55, the UE 5-01 may transmit a message (e.g., RRC reconfiguration complete message) for indicating completion of the handover to the target MN 5-05.

Also, at the same time, at step 5-60, the UE 5-01 may perform random access to the target SN 5-04.

At step 5-65, the target MN 5-05 may transmit an SN Reconfiguration Complete message to the target SN 5-04.

At step 5-70, the target MN 5-05 may transmit a message (e.g., Handover Success message) indicating that the handover has been successfully completed to the source MN 5-02.

At step 5-75, the source MN 5-02 may transmit an SN Release Request to the source SN 5-03.

At step 5-80, the source SN 5-03 may transmit an SN Release Request Ack message to the source MN 5-02.

At step 5-85, the source MN 5-02 may transmit an Xn-U Address Indication to the source SN 5-03.

At step 5-90, the source MN 5-02 may transmit a Handover Cancel message to other target MNs (e.g., 5-05, 5-06) for which handover has not been performed, to inform them of information about the handover procedure and configuration cancellation.

At step 5-95, other target MNs 5-05 and 5-06 that has received the Handover Cancel message may transmit information about SN configuration cancellation by transmitting an SN Release Request message to the SN 5-07 that has provided the CPC configuration associated with the corresponding MN.

At step 5-100, the candidate target MN 5-06 may receive an SN Release Request Ack message from the SN 5-07.

At step 5-105, the source MN 5-02 may receive an SN Status Transfer message from the source SN 5-03, and forward it to the target MN 5-05 at step 5-110.

The target MN base station 5-05 having received this may forward the received SN Status Transfer message to the target SN 5-04 at step 5-115.

At step 5-120, data forwarding (procedure for transmitting data to the target MN base station 5-05) from the UPF 5-08 may be performed.

At step 5-125, as an operation for path update, the target MN base station 5-05 may transmit a PDU session resource modification indication to the AMF 5-09.

At step 5-130, the AMF 5-09 and the UPF 5-08 may perform a bearer modification procedure.

At step 5-135, the UPF 5-08 may transmit a PDU packet to the target MN base station 5-05 to indicate a modification of the previous bearer.

At step 5-140, the UPF 5-08 may indicate a new path to the target SN base station 5-04.

At step 5-145, the AMF 5-09 may transmit a PDU session resource modification confirmation message indicating that the PDU session resource modification has been completed to the target MN base station 5-05.

At step 5-150, the target MN base station 5-05 may instruct the source MN base station 5-02 to release the UE context.

At step 5-155, the source MN base station 5-02 may instruct the source SN base station 5-03 to release the UE context.

Some of the steps related to FIGS. 5A to 5C may be omitted or listed in combination, without being limited to the above description.

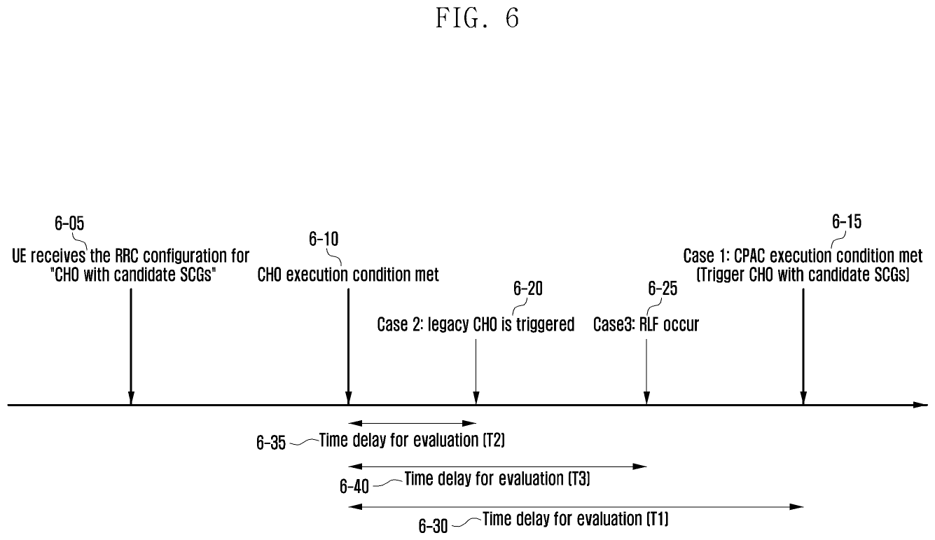

FIG. 6 is a diagram illustrating a scenario for storing information on whether to execute the CHO with candidate SCGs configuration in the UE according to an embodiment of the disclosure.

According to an embodiment, the CHO with candidate SCGs configuration may mean that two mobility technologies are performed simultaneously when two conditions (CHO condition, CPC condition) for the MN and the SN are satisfied at the same time; and whether the CHO condition is satisfied may be evaluated first, and then the CPC condition (e.g., condExecutionCond-r16) that can be performed simultaneously with the PCell to which the CHO is performed may be evaluated. Due to this, there may be an interruption time between evaluation of the CHO condition and following evaluation of the CPC condition (e.g., condExecutionCondPSCell-r18) for the multiple candidate PSCells. Since the performance may be lowered in terms of interruption compared to the legacy CHO, when the network base station provides the CHO with candidate SCGs configuration, the legacy CHO configuration may be transmitted together for the same PCell so that the legacy CHO can be executed when interruption of a specific time or more is expected to occur. According to an embodiment, the condition (e.g., threshold, etc.) applied to the CHO with candidate SCGs configuration may be set differently from the condition (e.g., threshold, etc.) applied to the legacy CHO.

Referring to FIG. 6, it is possible to exemplify a scenario that can be considered when extending the RA report illustrated in FIG. 3 to report operation information related to the CHO with candidate SCGs configuration.

At step 6-05, the UE may receive a CHO with candidate SCGs configuration from the base station. According to an embodiment, in relation to the configuration information, the UE may receive from the base station at least one of CHO configuration information, information about multiple candidate SCGs and CPC configuration information for the corresponding SCG, or legacy CHO configuration information. According to an embodiment, the UE may evaluate whether the provided CHO conditions for the candidate cells are satisfied first, and then evaluate the CPC conditions that can be executed simultaneously with the PCell on which the corresponding CHO is executed according to the received configuration information.

At step 6-10, if the CHO condition is satisfied through the measurement evaluation for the candidate PCell, the UE may evaluate the CPC conditions for multiple PSCells that can be executed simultaneously with the PCell on which the corresponding CHO is executed. After step 6-10, according to an embodiment, the following operations may be performed.

### 1. Case 1 (6-15)

According to an embodiment, as a case where the CPC condition that can be executed simultaneously with the PCell on which CHO is executed is satisfied, the pre-configured CHO and the CPC operation for the candidate SCG configuration may be triggered and executed simultaneously.
According to an embodiment, after the CHO condition is satisfied (6-10), the time when CHO and CPC operations are executed simultaneously may be defined as evaluation time T1 (6-30), and the UE may record this. The corresponding time may be interpreted as an additional interruption time (6-30) required compared to the legacy CHO.

### 2. Case 2 (6-20)

According to an embodiment, it may correspond to the case where the legacy CHO configuration set by the base station satisfies the condition and is triggered before the CHO and the CPC operation for the candidate SCG configuration are triggered simultaneously.
According to an embodiment, after the CHO condition is satisfied (6-10), the time during which the legacy CHO operation is executed may be defined as evaluation time T2 (6-35), and the UE may record this.

### 3. Case 3 (6-25)

According to an embodiment, this may correspond to the case where an RLF occurs to the corresponding serving cell (PCell) before the CHO and the CPC operation for the candidate SCG configuration are triggered simultaneously.
According to an embodiment, the time when RLF occurs after the CHO condition is satisfied (6-10) may be defined as evaluation time T3 (6-40), and the UE may record this.

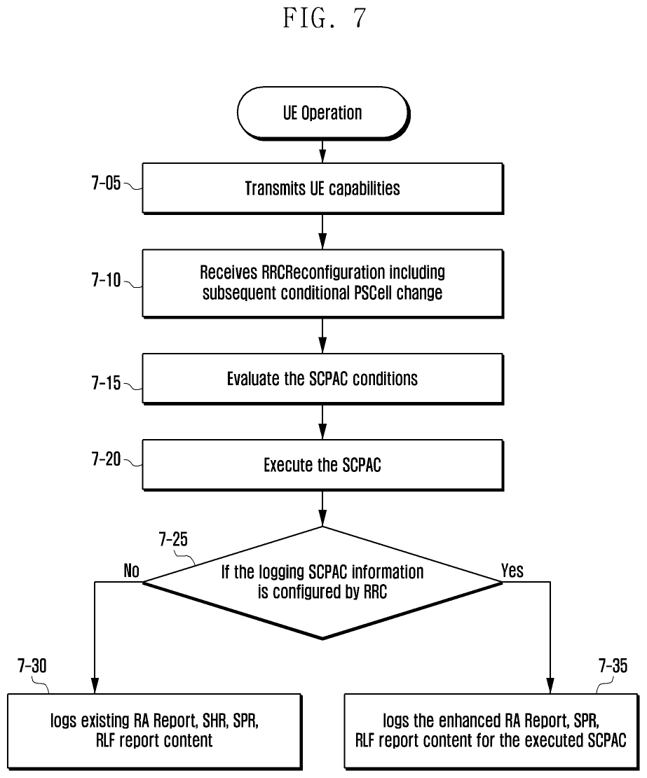

FIG. 7 is a diagram illustrating a UE operation for storing and reporting subsequent conditional PSCell change information to the base station according to an embodiment of the disclosure.

FIG. 7 illustrates, according to one embodiment, an operation in which the UE stores information related to RA, RLF, and SPR and then reports logged information to the base station upon request therefrom in relation to the subsequent conditional PSCell change (subsequent CPAC, SCPAC) illustrated in FIGS. 4A to 4D.

At step 7-05, the UE may report UE capability information to the base station in connected state. According to an embodiment, the UE capability information may include indicator information indicating whether RA report, RLF report, SHR, SPR enhancement operations are supported. This may correspond to the operation of reporting logging information for the subsequent conditional PSCell change operation.

At step 7-10, the UE may receive an RRC configuration message from the base station. This RRC configuration message may include configuration information for the subsequent conditional PSCell change. In addition, the RRC configuration message may also include an indication indicating whether the UE logs information for enhanced RA report, RLF report, SHR, SPR operations related to the subsequent conditional PSCell change. According to an embodiment, if the UE has a suitable UE capability, the UE may be configured to mandatorily perform when the subsequent conditional PSCell change is configured and the corresponding operation is triggered, in which case the above indication may be omitted.

At step 7-15, the UE may evaluate the condition for subsequent conditional PSCell change according to the RRC configuration received at step 7-10, and, at step 7-20, may execute the subsequent conditional PSCell change to a PSCell satisfying the configured CPC condition.

At step 7-25, if the base station does not instruct the UE to perform logging operation associated with subsequent conditional PSCell change via the RRC message provided at step 7-10 or does not provide configurations associated with subsequent conditional PSCell change, at step 7-30, the UE may log information about RA, RLF, SHR, and SPR currently occurred in the UE.

At step 7-25, if the base station instructs the UE to perform logging operation associated with subsequent conditional PSCell change via the RRC message provided at step 7-10 or provides configurations associated with subsequent conditional PSCell change, at step 7-35, the UE may log information about RA, RLF, and SPR for subsequent conditional PSCell change currently occurred in the UE.

According to an embodiment, only one of step 7-30 and step 7-35 may be performed, and some of the steps related to FIG. 7 may be performed or performed in combination.

According to an embodiment, information about RA, RLF, SPR for the above subsequent conditional PSCell change may include the following detailed information. The above RA report may be included in the SPR as well for transmission. That is, it may be included as RA-related information when the SPR is performed.

The following parameters may correspond to additional information required for reporting the subsequent conditional PSCell change in addition to the previously defined parameters. According to an embodiment, the parameters included in the existing RA, RLF, and SPR illustrated in FIG. 3 may also be applied as is. Additionally, the information included in the parameters below may include at least one of the disclosed information.

### 1. SPR (Successful PScell Change Report): RA Report Included

Information about the index where the PSCell change is executed: PSCell index or configuration index among multiple SCPAC configurations
SPR related information: source PSCell information (CGI (cell global identity), measurement value), target PSCell information (CGI or PCI-ARFCN (physical cell id-absolute radio frequency channel number), measurement value), measurement information of neighbor cells
Time delay of executed CPC (time between recently executed conditional configuration and the change toward the target PSCell)
Condition that triggered SCPAC (associated with measID containing CondExecutionCondPSCell-r18, including MO and ReportConfig information)
Used reference cell configuration information and indication of whether delta or complete configuration is applied
Cause value (raPurpose): PSCell change (reconfigurationWithSync) or introduction of new value (subsequent CPAC)

### 2. RLF Report

Apply the RLF report that applies to the legacy PSCell change, and provide the RLF report in the PSCell that has been performed up to the recent PSCell change after receiving the subsequent conditional PSCell change configuration. That is, SCPAC-related information (SuccessPSCell-Report IE) prior to the current RLF occurrence is provided in a list form.
PSCell Information: information about the PSCell where the RLF occurred. May be provided as CGI/PCI-ARFCN.
Failure cause: T310 expiry, RA problem, RLC maximum Tx, or the like
Elapsed time from which SCG failure has been declared (T316)
Condition that triggers SCPAC operation (associated with measID containing CondExecutionCondPSCell-r18, including MO and ReportConfig information)

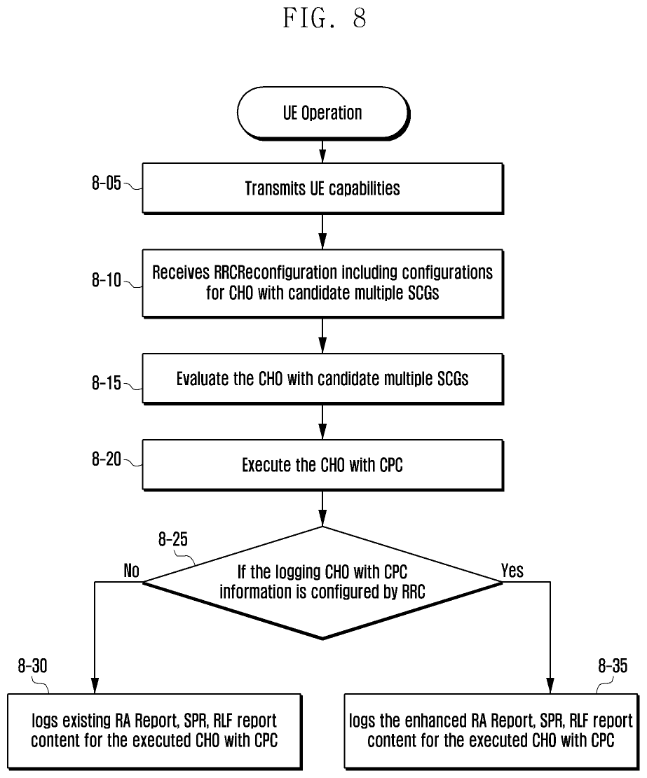

FIG. 8 is a diagram illustrating a UE operation for storing and reporting conditional PSCell change information depending on the CHO with candidate SCGs configuration to the base station according to an embodiment of the disclosure. According to an embodiment, in relation to the conditional PSCell change operation according to the CHO with multiple candidate SCGs configuration illustrated in FIGS. 5A, 5B and 6, the UE may store information related to RA, RLF, SHR and SPR and then report the logged information to the base station upon the base station's request.

At step 8-05, the UE may report UE capability information to the base station in connected state. According to an embodiment, the UE capability information may include indicator information indicating whether RA report, RLF report, SHR, SPR enhancement operations are supported. This may correspond to the operation of reporting logging information about the conditional PSCell change according to the CHO with candidate SCGs configuration.

At step 8-10, the UE may receive an RRC configuration message from the base station. According to an embodiment, this RRC configuration message may include configuration information for the conditional PSCell change according to the CHO with candidate SCGs configuration. In addition, it may also include an indication indicating whether the UE logs information for enhanced RA report, RLF report, SHR, SPR operations in relation to the conditional PSCell change according to the CHO with candidate SCGs configuration. According to an embodiment, if the UE has a suitable UE capability, the UE may be configured to mandatorily perform when the conditional PSCell change is configured and the corresponding operation is triggered according to the related CHO with candidate SCGs configuration, in which case the above indication may be omitted.

At step 8-15, the UE may evaluate the condition for conditional PSCell change according to the CHO with candidate SCGs configuration in accordance with the RRC configuration received at step 8-10, and at step 8-20, it may execute simultaneous cell changes toward the PCell and PSCell that satisfy the configured CHO and CPC conditions. FIG. 6 may be illustrated in relation to the above step.

At step 8-25, if the base station does not instruct the UE to perform logging operation associated with the conditional PSCell change according to the CHO with candidate SCGs configuration via the RRC message provided at step 8-10 or does not provide configurations associated with the conditional PSCell change according to the CHO with candidate SCGs configuration, at step 8-30, the UE may log information about RA, RLF, SHR, and SPR currently occurred in the UE.

At step 8-25, if the base station instructs the UE to perform logging operation associated with the conditional PSCell change according to the CHO with candidate SCGs configuration via the RRC message provided at step 8-10 or provides configurations associated with the conditional PSCell change according to the CHO with candidate SCGs configuration, at step 8-35, the UE may log information about RA, RLF, SHR, and SPR currently occurred in the UE in relation to the conditional PSCell change according to the CHO with candidate SCGs configuration.

According to an embodiment, only one of step 8-30 and step 8-35 may be performed, and some of the steps related to FIG. 8 may be performed or performed in combination.

According to an embodiment, information about RA, RLF, SPR for the above conditional PSCell change according to the CHO with candidate SCGs configuration may include the following detailed information. The above RA report may be included in the SPR as well for transmission. That is, it may be included as RA-related information when the SPR is performed.

The following parameters may correspond to additional information required for reporting the conditional PSCell change according to the CHO with candidate SCGs configuration in addition to the previously defined parameters. According to an embodiment, the parameters included in the existing RA, RLF, and SPR illustrated in FIG. 3 may also be applied as is. Additionally, the information included in the parameters below may include at least one of the disclosed information.

### 1. Successful Handover Report (SHR): Including RA Report on Executed CHO and CPAC.

Applied CHO type: indicates whether CHO only (legacy CHO) or CHO with CPC
Information about the index where CHO and PSCell change are performed: PCell/PSCell index or configuration index among multiple SCPAC configurations
SHR related information: source PCell information (CGI, measurement value), target PCell information (CGI or PCI-ARFCN, measurement value), measurement information of neighbor cells
SPR related information: source PSCell information (CGI, measurement value), target PSCell information (CGI or PCI-ARFCN, measurement value), measurement information of neighbor cells
Handover delay information (evaluation time)
   Time from when the CHO condition is met to when actual handover is executed (CPAC condition is met and CHO/CPAC are triggered simultaneously) (Case 1, T1, 6-30)
   Time from when the CHO condition is satisfied to when actual handover is executed (legacy CHO only) (Case 2, T2, 6-35)
   After the CHO condition is satisfied, the time from when the CPAC condition is satisfied to when the CHO and CPAC (CHO+CPAC) are actually executed simultaneously
Condition that has triggered the CHO (associated with measID containing condExecutionCond-r16, including MO and ReportConfig information)
Condition that has triggered the SCPAC (associated with measID containing CondExecutionCondPSCell-r18, including MO and ReportConfig information)
Cause value (raPurpose): CHO (reconfigurationWithSync) or introducing a new value (CHO with CPC)

### 1. RLF Report

Apply the RLF report applied to legacy CHO and PSCell change, and additionally add the following cases to the HO failure type
   CHO evaluation to PCellHO-Failure: if RLF occurs during PCell HO after satisfaction of the CHO condition
   CHO evaluation to CPAC-Failure: if RLF occurs during a PSCell change after satisfaction of the CHO condition
PCell Information: information about the PCell where RLF has occurred. May be provided as CGI/PCI-ARFCN.
PSCell Information: information about the PSCell where RLF has occurred. May be provided as CGI/PCI-ARFCN
Failure cause: T310 expiry, RA problem, RLC maximum Tx, or the like
Evaluation time for CHO alone or CHO with CPC operation
   Time from when CHO condition is satisfied to when handover failure occurs (Case 2, T3; 6-40)
   Time from when CPAC condition is satisfied to when handover failure occurs
   Through the above information, the base station may know the difference in evaluation time between when CHO is executed alone and when CHO and CPAC are executed simultaneously, and based on this, it may update the CHO and CPAC conditions and configurations.
Conditions that trigger CHO and CPAC operations (associated with measID, including MO and ReportConfig information)

According to an embodiment, reporting for RA, RLF, SHR, SPR related to FIGS. 7 and 8 may be performed by extending the existing RRC IEs, but a new RRC IE may be introduced to generate report messages for RA, RLF, SHR, SPR dedicated to SCPAC and CHO with CPC.

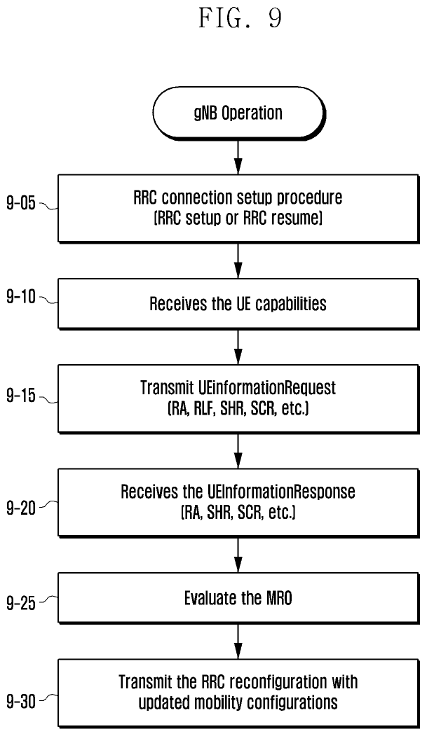

FIG. 9 is a diagram illustrating a base station operation for receiving enhanced mobility information from the UE and storing the same according to an embodiment of the disclosure. According to an embodiment, in relation to FIG. 9, the base station operation may include controlling all of the operations illustrated in FIGS. 7 and 8 according to an embodiment, or controlling the operation of the UE according to an embodiment, and in FIG. 9, an operation may be illustrated where a new base station requests a report from the UE.

At step 9-05, the base station may perform a procedure for establishing an RRC connection with the UE. According to an embodiment, it may include transmitting and receiving RRC messages for RRC setup or RRC resume procedures (e.g., RRCSetupRequest, RRCSetup, RRCSetupComplete, RRCResumeRequest, RRCResume, RRCResumeComplete).

At step 9-10, the base station may receive UE capabilities from the UE. The UE capability may be transmitted via a message including terminal capabilities (e.g., UECapabilityInformation message), and in the disclosure, it may include support for simultaneous CPC execution for SCPAC and CHO with multiple SCGs, and the ability to log related information after execution of the corresponding function.

At step 9-15, the base station may request a report for RA, RLF, SHR, and SPR by transmitting a report requesting message (e.g., UEInformationRequest message) to the UE. According to an embodiment, when requesting a report for RA, RLF, SHR, and SPR, existing parameters may be reused, but indications of enhanced mobility techniques (e.g., subsequent conditional PSCell change, simultaneous execution of CHO and CPC) according to an embodiment may be explicitly distinguished and requested. According to an embodiment, when reusing the existing requesting scheme, the UE may also transmit the logging information according to the existing indication if the values stored in the previous cell are related to enhanced mobility techniques (e.g., subsequent conditional PSCell change, simultaneous execution of CHO and CPC).

At step 9-20, the base station may receive a response message (e.g., UEInformationResponse message) from the UE in reply to the report on the RA, RLF, SHR, and SPR requested in the above step, and this message may include information on the RA, RLF, SHR, and SPR transmitted by the UE. The above information may include at least one of the information included in the parameters according to an embodiment.

At step 9-25, the base station may perform mobility robust optimization (MRO) operation based on the information about RA, RLF, SHR, and SPR received from the UE. For example, it may perform update operations on the parameters and configuration information for optimal mobility based on the reported values.

At step 9-30, the base station may transmit, to the UE, RRC configuration information reflecting the mobility-related configuration information adjusted at the above step.

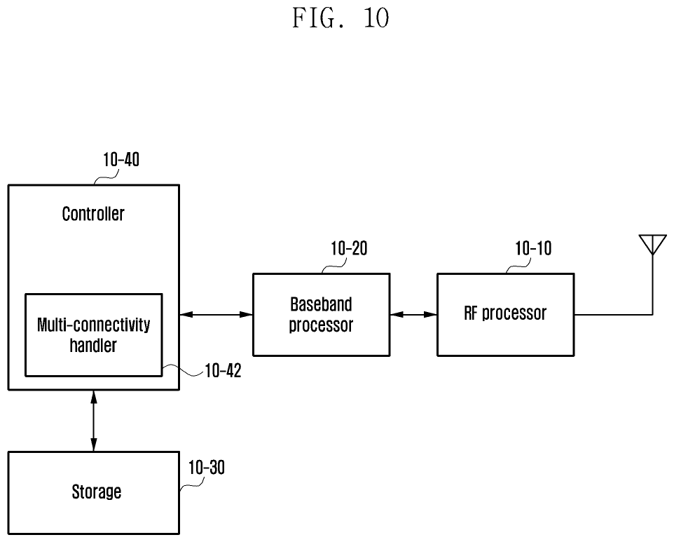

FIG. 10 is a diagram illustrating the structure of a UE according to an embodiment of the disclosure.

With reference to the drawing, the UE may include a radio frequency (RF) processor 10-10, a baseband processor 10-20, a storage 10-30, and a controller 10-40.

The RF processor 10-10 may perform a function for transmitting and receiving a signal through a radio channel, such as signal band conversion and amplification. That is, the RF processor 10-10 may perform up-conversion of a baseband signal provided from the baseband processor 10-20 into an RF-band signal and transmit it through an antenna, and may perform down-conversion of an RF-band signal received through an antenna into a baseband signal. For example, the RF processor 10-10 may include a transmission filter, a reception filter, an amplifier, a mixer, an oscillator, a digital-to-analog converter (DAC), and an analog-to-digital converter (ADC). Although only one antenna is illustrated in the drawing, the UE may be provided with a plurality of antennas. Also, the RF processor 10-10 may include a plurality of RF chains. Further, the RF processor 10-10 may perform beamforming. For beamforming, the RF processor 10-10 may adjust phases and magnitudes of individual signals transmitted and received through the plural antennas or antenna elements. Further, the RF processor may perform multi input multi output (MIMO), and may receive several layers during a MIMO operation.

The baseband processor 10-20 may perform conversion between a baseband signal and a bit stream in accordance with the physical layer specification of the system. For example, during data transmission, the baseband processor 10-20 may generate complex symbols by encoding and modulating a transmission bit stream. Further, during data reception, the baseband processor 10-20 may restore a reception bit stream by demodulating and decoding a baseband signal provided from the RF processor 10-10. For example, in the case of utilizing orthogonal frequency division multiplexing (OFDM), for data transmission, the baseband processor 10-20 may generate complex symbols by encoding and modulating a transmission bit stream, map the complex symbols to subcarriers, and compose OFDM symbols through inverse fast Fourier transform (IFFT) operation and cyclic prefix (CP) insertion. Further, for data reception, the baseband processor 10-20 may divide a baseband signal provided from the RF processor 10-10 in units of OFDM symbols, restore the signals mapped to subcarriers through fast Fourier transform (FFT) operation, and restore the reception bit stream through demodulation and decoding.

The baseband processor 10-20 and the RF processor 10-10 may transmit and receive signals as described above. The baseband processor 10-20 and the RF processor 10-10 may be called a transmitter, a receiver, a transceiver, or a communication unit. Further, to support different radio access technologies, at least one of the baseband processor 10-20 or the RF processor 10-10 may include a plurality of communication modules. In addition, to process signals of different frequency bands, at least one of the baseband processor 10-20 or the RF processor 10-10 may include different communication modules. For example, the different radio access technologies may include a wireless LAN (e.g., IEEE 802.11), a cellular network (e.g., LTE), and the like. In addition, the different frequency bands may include a super high frequency (SHF) band (e.g., 2.NRHz, NRhz) and a millimeter wave (mmWave) band (e.g., 60 GHz).

The storage 10-30 may store data such as basic programs, application programs, and configuration information for the operation of the UE. In particular, the storage 10-30 may store information about a second access node that performs wireless communication using a second radio access technology. The storage 10-30 may provide stored data in response to a request from the controller 10-40.

The controller 10-40 may control the overall operation of the UE. For example, the controller 10-40 may transmit and receive signals through the baseband processor 10-20 and the RF processor 10-10. Further, the controller 10-40 may write or read data to or from the storage 10-30. To this end, the controller 10-40 may include at least one processor. The controller 10-40 may also include a multi-connectivity handler 10-42. For example, the controller 10-40 may include a communication processor (CP) for controlling communication, and an application processor (AP) for controlling higher layers such as application programs.

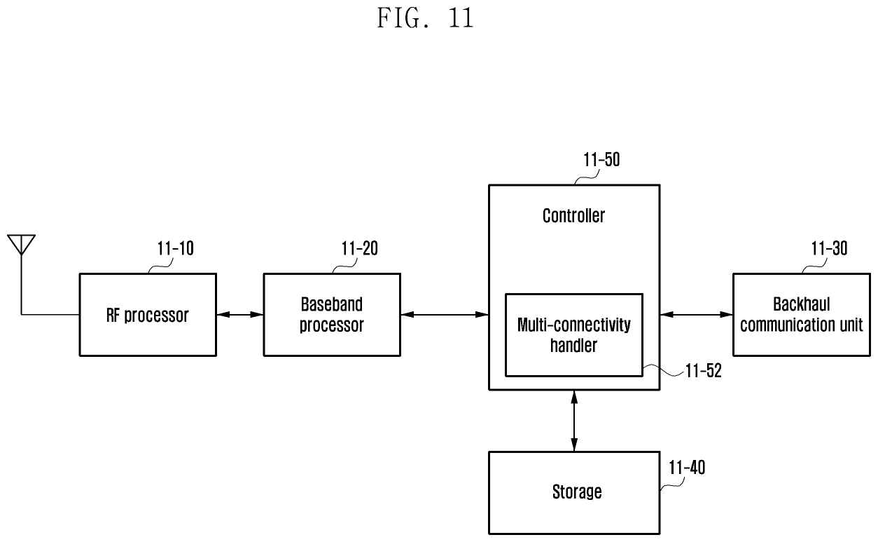

FIG. 11 is a diagram illustrating the structure of a base station according to an embodiment of the disclosure.

Referring to FIG. 11, the base station may include an RF processor 11-10, a baseband processor 11-20, a backhaul communication unit 11-30, a storage 11-40, and a controller 11-50.

The RF processor 11-10 may perform a function for transmitting and receiving a signal through a radio channel, such as signal band conversion and amplification. That is, the RF processor 11-10 may perform up-conversion of a baseband signal provided from the baseband processor 11-20 into an RF-band signal and transmit the converted signal through an antenna, and may perform down-conversion of an RF-band signal received through an antenna into a baseband signal. For example, the RF processor 11-10 may include a transmission filter, a reception filter, an amplifier, a mixer, an oscillator, a DAC, and an ADC. Although only one antenna is illustrated in the drawing, the first access node may be provided with a plurality of antennas. Additionally, the RF processor 11-10 may include a plurality of RF chains. Further, the RF processor 11-10 may perform beamforming. For beamforming, the RF processor 11-10 may adjust phases and amplitudes of individual signals transmitted and received through plural antennas or antenna elements. The RF processor may perform downlink MIMO operation by transmitting one or more layers.

The baseband processor 11-20 may perform conversion between a baseband signal and a bit stream in accordance with the physical layer specification of a first radio access technology. For example, for data transmission, the baseband processor 11-20 may generate complex symbols by encoding and modulating a transmission bit stream. Further, for data reception, the baseband processor 11-20 may restore a reception bit stream by demodulating and decoding a baseband signal provided from the RF processor 11-10. For example, in the case of utilizing OFDM, for data transmission, the baseband processor 11-20 may generate complex symbols by encoding and modulating a transmission bit stream, map the complex symbols to subcarriers, and compose OFDM symbols through IFFT operation and CP insertion. Further, for data reception, the baseband processor 11-20 may divide a baseband signal provided from the RF processor 11-10 in units of OFDM symbols, restore the signals mapped to subcarriers through FFT operation, and restore the reception bit stream through demodulation and decoding. The baseband processor 11-20 and the RF processor 11-10 may transmit and receive signals as described above. Hence, the baseband processor 11-20 and the RF processor 11-10 may be called a transmitter, a receiver, a transceiver, a communication unit, or a wireless communication unit.

The backhaul communication unit 11-30 may provide an interface for communication with other nodes in the network. That is, the backhaul communication unit 11-30 may convert a bit stream, which is to be transmitted from the base station to another node, for example, a secondary base station or the core network, into a physical signal, and may convert a physical signal received from another node into a bit stream.

The storage 11-40 may store data such as basic programs, application programs, and configuration information for the operation of the base station. In particular, the storage 11-40 may store information on a bearer allocated to a connected UE and measurement results reported from the connected UE. Further, the storage 11-40 may store information used as a criterion for determining whether to provide or suspend multi-connectivity to the UE. In addition, the storage 11-40 may provide stored data in response to a request from the controller 11-50.

The controller 11-50 may control the overall operation of the primary base station. For example, the controller 11-50 may transmit and receive signals through the baseband processor 11-20 and the RF processor 11-10 or through the backhaul communication unit 11-30. Further, the controller 11-50 writes or reads data to or from the storage 11-40. The controller 11-50 may also include a multi-connectivity handler 11-52. To this end, the controller 11-50 may include at least one processor.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
identifying whether a first condition associated with a conditional handover (CHO) and a second condition associated with a conditional primary secondary cell (PSCell) addition or change (CPAC) are met;
logging information on a time associated with the first condition or the second condition;
receiving, from a first base station, a first message requesting at least one of information on a random access (RA), information on a radio link failure (RLF), information on a handover, information on a PSCell, or the information on the time; and
transmitting, to the first base station, a second message comprising at least one of the information on the RA, the information on the RLF, the information on the handover, the information on the PSCell, or the information on the time,
wherein the information on the time comprises a first time gap between a first time when the first condition is met and a second time when the second condition is met.

2. The method of claim 1, further comprising:
transmitting, to the first base station or a second base station, capability information associated with a CHO with candidate secondary cell groups (SCGs); and
receiving, from the first base station or the second base station, configuration information associated with the CHO with the candidate SCGs,
wherein the configuration information comprises the first condition and the second condition.

3. The method of claim 1, wherein the information on the time further comprises at least one of a second time gap between the first time when the first condition is met and a third time when a third condition associated with the CHO is met or a third time gap between the first time when the first condition is met and a fourth time when an RLF occurs.

4. The method of claim 1, further comprising:
in case that the first condition and the second condition are met, performing the CHO with a conditional PSCell change (CPC).

5. A method performed by a first base station in a wireless communication system, the method comprising:
transmitting, to a terminal, a first message requesting at least one of information on a random access (RA), information on a radio link failure (RLF), information on a handover, information on a primary secondary cell (PSCell), or information on a time associated with a first condition or a second condition; and
receiving, from the terminal, a second message comprising at least one of the information on the RA, the information on the RLF, the information on the handover, the information on the PSCell, or the information on the time associated with the first condition or the second condition,
wherein the information on the time comprises a first time gap between a first time when the first condition is met and a second time when the second condition is met,
wherein the first condition is associated with a conditional handover (CHO), and
wherein the second condition is associated with a conditional PSCell addition or change (CPAC).

6. The method of claim 5, further comprising:
receiving, from the terminal, capability information associated with a CHO with candidate secondary cell groups (SCGs); and
transmitting, to the terminal, configuration information associated with the CHO with the candidate SCGs,
wherein the configuration information comprises the first condition and the second condition.

7. The method of claim 5,
wherein the information on the time further comprises at least one of a second time gap between the first time when the first condition is met and a third time when a third condition associated with the CHO is met or a third time gap between the first time when the first condition is met and a fourth time when an RLF occurs, and
wherein, in case that the first condition and the second condition are met, the CHO with a conditional PSCell change (CPC) is performed.

8. A terminal in a wireless communication system, the terminal comprising:
a transceiver; and
at least one processor coupled with the transceiver and configured to:
identify whether a first condition associated with a conditional handover (CHO) and a second condition associated with a conditional primary secondary cell (PSCell) addition or change (CPAC) are met,
log information on a time associated with the first condition or the second condition,
receive, from a first base station, a first message requesting at least one of information on a random access (RA), information on a radio link failure (RLF), information on a handover, information on a PSCell, or the information on the time, and
transmit, to the first base station, a second message comprising at least one of the information on the RA, the information on the RLF, the information on the handover, the information on the PSCell, or the information on the time,
wherein the information on the time comprises a first time gap between a first time when the first condition is met and a second time when the second condition is met.

9. The terminal of claim 8,
wherein the at least one processor is further configured to:
transmit, to the first base station or a second base station, capability information associated with a CHO with candidate secondary cell groups (SCGs), and
receive, from the first base station or the second base station, configuration information associated with the CHO with the candidate SCGs, and
wherein the configuration information comprises the first condition and the second condition.

10. The terminal of claim 8, wherein the information on the time further comprises at least one of a second time gap between the first time when the first condition is met and a third time when a third condition associated with the CHO is met or a third time gap between the first time when the first condition is met and a fourth time when an RLF occurs.

11. The terminal of claim 8, wherein the at least one processor is further configured to:
in case that the first condition and the second condition are met, perform the CHO with a conditional PSCell change (CPC).

12. A first base station in a wireless communication system, the first base station comprising:
a transceiver; and
at least one processor coupled with the transceiver and configured to:
transmit, to a terminal, a first message requesting at least one of information on a random access (RA), information on a radio link failure (RLF), information on a handover, information on a primary secondary cell (PSCell), or information on a time associated with a first condition or a second condition, and
receive, from the terminal, a second message comprising at least one of the information on the RA, the information on the RLF, the information on the handover, the information on the PSCell, or the information on the time associated with the first condition or the second condition,
wherein the information on the time comprises a first time gap between a first time when the first condition is met and a second time when the second condition is met,
wherein the first condition is associated with a conditional handover (CHO), and
wherein the second condition is associated with a conditional PSCell addition or change (CPAC).

13. The first base station of claim 12, wherein the at least one processor is further configured to:
receive, from the terminal, capability information associated with a CHO with candidate secondary cell groups (SCGs), and
transmit, to the terminal, configuration information associated with the CHO with the candidate SCGs,
wherein the configuration information comprises the first condition and the second condition.

14. The first base station of claim 12, wherein the information on the time further comprises at least one of a second time gap between the first time when the first condition is met and a third time when a third condition associated with the CHO is met or a third time gap between the first time when the first condition is met and a fourth time when an RLF occurs.

15. The first base station of claim 12, wherein, in case that the first condition and the second condition are met, the CHO with a conditional PSCell change (CPC) is performed.
